(19) United States
(12) Patent Application Publication
(10) Pub. No.: US 2024/0153662 A1
(43) Pub. Date: May 9, 2024

(54) METHODS AND SYSTEMS FOR PRODUCING RADIONUCLIDES USING NEUTRON ACTIVATION

(71) Applicant: FUSE ENERGY TECHNOLOGIES CORP., New York, NY (US)

(72) Inventors: Paul HARRIS, Montreal (CA); Ayan CHOUDHURY, Napierville (CA); Zahra SEIFOLLAHI MOGHADAM, Napierville (CA); Raymond GOLINGO, Napierville (CA); Jean-Christoph BTAICHE, Napierville (CA)

(21) Appl. No.: 18/261,700

(22) PCT Filed: Jan. 21, 2022
(86) PCT No.: PCT/US2022/013262

§ 371 Date: Jul. 17, 2023

Related U.S. Application Data
(60) Provisional application No. 63/140,658, filed on Jan. 22, 2021.

(51) Int. Cl. G21G 1/00; G21B 1/03; G21G 1/06

(52) U.S. Cl. CPC G21G 1/001; G21B 1/03; G21G 1/06; G21G 2001/0036

(57) ABSTRACT

Methods and systems for producing radionuclides by neutron activation are disclosed. A system for radionuclide production can include a compact plasma-based fusion neutron source, for example, a Z-pinch-based neutron source, configured to generate a neutron flux, and a target holder configured to hold a target comprising neutron-activatable nuclides, for example, ⁹⁸Mo, where the target holder is arranged with respect to the compact plasma-based fusion neutron source to expose the target to the neutron flux and produce radionuclides, for example, ⁹⁹Mo, through neutron activation of the neutron-activatable nuclides. In some embodiments, the target holder is configured to move the target along a circulation path arranged with respect to the plasma-based fusion neutron source during exposure of the target to the neutron flux.

### CROSS-REFERENCE TO RELATED PATENT APPLICATION(S)

The present application claims priority to U.S. Provisional Patent Application No. 63/140,658 filed on Jan. 22, 2021, which is incorporated herein by reference in its entirety.

### TECHNICAL FIELD

The technical field generally relates to radionuclide production, and more particularly, to methods and systems for producing radionuclides by neutron activation.

### BACKGROUND

Radionuclides are used in nuclear medicine for diagnosis, treatment, and research. Technetium-99m (^{99m}Tc) is the most widely used medical isotope today, accounting for about 80% of all nuclear medicine procedures worldwide. Radiopharmaceuticals based on ^{99m}Tc are used for imaging and diagnosis in a large number of tissue and organ systems, including the brain, skeleton, heart, circulatory system, kidneys, lungs, spleen, thyroid, and liver. ^{99m}Tc used in nuclear medicine today is produced almost exclusively from the radioactive decay of molybdenum-99 (⁹⁹Mo). Since both ⁹⁹Mo and ^{99m}Tc have relatively short half-lives of 66 hours and 6 hours, respectively, they cannot be stockpiled. As a result, the supply chain for delivering ⁹⁹Mo/^{99mTc} to hospitals and other medical facilities is complex and faces various challenges. Conventionally, ⁹⁹Mo can be produced by various processes using nuclear research reactors and particle accelerators. The two main processes for producing ⁹⁹Mo are fission-based processes and neutron-capture-based processes. Reactors can be used to produce ⁹⁹Mo by fission of uranium-235 (²³⁵U) through the reaction ²³⁵U(n,f)⁹⁹Mo·which is currently the most widely used method for producing ⁹⁹Mo—or by direct neutron activation of ⁹⁸Mo through the reaction ⁹⁹Mo(n,γ)⁹⁹Mo. Accelerators, including linacs, cyclotrons, and spallation sources, can be used to produce ⁹⁹Mo by irradiating target materials such as ²³⁵U, ²³⁸U, ⁹⁸Mo, and ¹⁰⁰Mo—with particles such as neutrons, protons, and photons. Accelerators can also be used to produce ⁹⁹mTc directly by proton irradiation of ¹⁰⁰Mo. While conventional methods for producing ⁹⁹Mo using reactors and accelerators have advantages, they also have a number of limitations and drawbacks. Non-limiting examples include, to name a few, high costs, large footprint, lack of scalability, complex chemical processing. material shortage (e.g., uranium), as well as various environmental, waste management, nuclear proliferation, regulatory, and security issues. Challenges therefore remain in the production of ⁹⁹Mo and other radionuclides used in nuclear medicine and other fields.

### SUMMARY

The present description generally relates to radionuclide production techniques using compact plasma-based fusion neutron sources, such as Z-pinch-based neutron sources and field-reversed-configuration (FRC)-based neutron sources, to name a few.

In accordance with an aspect, there is provided a system for radionuclide production, the system including:
a compact plasma-based fusion neutron source configured to generate a neutron flux: and
a target holder configured to hold a target including neutron-activatable nuclides, the target holder being arranged with respect to the compact plasma-based fusion neutron source to expose the target to the neutron flux and produce radionuclides through neutron activation of the neutron-activatable nuclides.

In some embodiments, the produced radionuclides include ⁹⁹Mo. In some embodiments, the neutron-activatable nuclides include ⁹⁸Mo, and ⁹⁹Mo is produced from ⁹⁸Mo through the reaction ⁹⁸Mo(n,γ)⁹⁹Mo, where n stands for a neutron and γ stands for a gamma particle. In some embodiments, the target includes MoO₃ dissolved in a solution. In some embodiments, the neutron-activatable nuclides include ¹⁰Mo, and wherein ⁹⁹Mo is produced from ¹⁰⁰Mo through the reaction ¹⁰⁰Mo(n,2n)⁹⁹Mo, wherein n stands for a neutron.

In some embodiments, the produced radionuclides include a single type of radionuclides, which may or may not be ⁹⁹Mo. In some embodiments, the produced radionuclides include multiple types of radionuclides, which may or may not include ⁹⁹Mo. Non-limiting examples of possible types of radionuclides that may be produced besides ⁹⁹Mo include, to name a few, ²²⁵Ac, ²²⁷aAc, ¹⁹Te, ⁶⁴Cu, ⁶⁷Cu, ³²P ⁴⁷Sc, ¹⁵³Sm, ¹⁷⁷Lu, ¹⁸⁶Re, ⁷⁵Se, ¹⁰³Pd, ¹⁹²Ir, ¹⁰⁹Cd, ³H, ¹⁴C, ⁵¹Cr, ⁵²Fe, ⁵⁹Fe, ⁶⁰Co, ⁸⁹Sr, ⁹⁰Y, ¹¹³Sn, ¹²⁴Xe, ¹³⁰T, and ¹⁶⁶Ho.

In some embodiments, the target holder is configured to maintain the target stationary with respect to the compact plasma-based fusion neutron source during exposure of the target to the neutron flux.

In some embodiments, the target holder is configured to move the target with respect to the compact plasma-based fusion neutron source during exposure of the target to the neutron flux. In some embodiments, the target is a fluid material containing the neutron-activatable nuclides.

In some embodiments, the target holder includes at least one conduit exposed to the neutron flux and configured to circulate a flow of the target therealong, each conduit including a conduit inlet configured to receive the flow of the target prior to exposure of the target to the neutron flux, and a conduit outlet configured to discharge the flow of the target after exposure of the target to the neutron flux. In some embodiments, the system further includes a flow moving device configured to control the flow of the target along the at least one conduit. In some embodiments, the at least one conduit includes a helical pattern.

In some embodiments, the at least one conduit includes a single conduit.

In some embodiments, the at least one conduit includes a plurality of conduits. In some embodiments, the plurality of conduits includes a first conduit configured to circulate a first flow of the target including a first type of neutron-activatable nuclides, and a second conduit configured to circulate a second flow of the target including a second type of neutron-activatable nuclides different from the first type of neutron-activatable nuclides. In some embodiments, the neutron-activatable nuclides of the first type include ⁹⁹Mo, from which ⁹⁹Mo is produced as a first type of radionuclides through the reaction ⁹⁸Mo(n,γ)⁹⁹Mo, and the neutron-activatable nuclides of the second type include ¹⁰⁰Mo, from which ⁹⁹Mo is produced as a second type of radionuclides through the reaction ¹⁰⁰Mo(n,2n)⁹⁹Mo.

In some embodiments, the compact plasma-based fusion neutron source is configured to generate the neutron flux with an average neutron energy ranging from about 2 MeV to about 15 MeV.

In some embodiments, the system further includes a neutron moderator arranged in a path of the neutron flux and configured to reduce an average neutron energy of the neutron flux prior to the neutron flux reaching the target. In some embodiments, the neutron moderator is configured to reduce the average neutron energy of the neutron flux to within a range of about 0.025 eV to about 300 eV. The neutron moderator may be made of various moderator materials, non-limiting examples of which include, to name a few, water, heavy water, graphite, beryllium, polyethylene, hydrocarbons, and paraffin wax.

In some embodiments, the system further includes a radionuclide extractor configured to receive the exposed target from the target holder and extract the produced radionuclides from the exposed target.

In some embodiments, the system further includes a target recycling unit configured to receive the exposed target from the target holder and recycle non-activated neutron-activatable nuclides from the exposed target for use in further production of radionuclides.

In some embodiments, the compact plasma-based fusion neutron source includes a Z-pinch-based neutron source including a reaction chamber having a Z-pinch axis, the Z-pinch-based neutron source being configured to form a Z-pinch plasma along the Z-pinch axis inside the reaction chamber and generate the neutron flux from the Z-pinch plasma.

In some embodiments, the Z-pinch-based neutron source includes: a plasma confinement device including the reaction chamber, an inner electrode, and an outer electrode surrounding the inner electrode to define therebetween an acceleration region of the reaction chamber, the outer electrode extending axially beyond the inner electrode along the Z-pinch axis to define an assembly region of the reaction chamber adjacent the acceleration region; a plasma formation and injection device configured to form a precursor plasma outside the reaction chamber and inject the precursor plasma inside the acceleration region; and a main power supply configured to supply power to the plasma confinement device to apply a voltage between the inner electrode and the outer electrode to cause the precursor plasma to flow along the acceleration region and into the assembly region and to be compressed into the Z-pinch plasma along the Z-pinch axis in the assembly region. In some embodiments, the plasma formation and injection device includes a plasma generator configured to generate the precursor plasma, and a plasma injector configured to inject the precursor plasma into the acceleration region. In some embodiments, the plasma generator includes: an inner electrode, and an outer electrode surrounding the inner electrode to define a plasma formation region therebetween, the outer electrode extending beyond the inner electrode along a plasma formation axis to enclose a plasma transport channel extending from the plasma formation region to the plasma injector along the plasma formation axis. In some embodiments, the plasma formation and injection device includes a process gas supply unit configured to supply a process gas into the plasma formation region, and a plasma formation power supply configured to apply a voltage between the inner electrode and the outer electrode of the plasma generator to energize the process gas into the precursor plasma and cause the precursor plasma to flow along the plasma formation region and through the plasma transport channel to reach the plasma injector for injection of the precursor plasma into the acceleration region.

In some embodiments, the Z-pinch-based neutron source includes: a plasma confinement device including the reaction chamber, an inner electrode, and an outer electrode surrounding the inner electrode to define therebetween an acceleration region of the reaction chamber, the outer electrode extending axially beyond the inner electrode along the Z-pinch axis to define an assembly region of the reaction chamber adjacent the acceleration region; a precursor gas supply device configured to supply a precursor gas inside the acceleration region; and a main power supply configured to supply power to the plasma confinement device to apply a voltage between the inner electrode and the outer electrode to energize the precursor gas into a precursor plasma and cause the precursor plasma to flow along the acceleration region and into the assembly region and to be compressed into the Z-pinch plasma along the Z-pinch axis in the assembly region.

In some embodiments, the Z-pinch-based neutron source is configured to form the Z-pinch plasma with an embedded radially sheared axial flow.

In some embodiments, the target holder is configured to flow the target along a circulation path extending helically around the Z-pinch axis over an axial portion of the assembly region. In some embodiments, the circulation path is disposed radially outwardly of the outer electrode. In some embodiments, the circulation path is disposed inside the outer electrode.

In some embodiments, the Z-pinch-based neutron source includes: a plasma confinement device including the reaction chamber, a first compression electrode disposed at a first end of the reaction chamber, and a second compression electrode disposed at a second end of the reaction chamber spaced apart from the first end along the Z-pinch axis; a precursor supply device coupled to the plasma confinement device and including an inner precursor supply unit including an inner injector, the inner precursor supply unit being configured to supply, through the inner injector, an inner precursor medium into the reaction chamber; and an outer precursor supply unit including an outer injector disposed radially outwardly of the inner injector with respect to the Z-pinch axis, the outer precursor supply unit being configured to supply, through the outer injector, an outer precursor plasma into the reaction chamber at an outer velocity: and a main power supply configured to supply power to the plasma confinement device to apply a voltage between the first compression electrode and the second compression electrode configured to energize and compress the inner precursor medium and the outer precursor plasma into the Z-pinch plasma with a radially sheared axial flow. In some embodiments, the inner precursor medium is an inner precursor plasma, and wherein the inner precursor supply unit is configured to supply the inner precursor plasma into the reaction chamber at an inner velocity different from the outer velocity of the outer precursor plasma. In some embodiments, the inner precursor medium is an inner precursor gas, and wherein the inner precursor supply unit includes an inner precursor gas source configured to store the inner precursor gas, and an inner precursor gas supply line configured to transport the inner precursor gas from the inner precursor gas source to the inner injector for injection of the inner precursor gas into the reaction chamber.

In some embodiments, the target holder is configured to flow the target along a circulation path extending helically around the Z-pinch axis over an axial portion of the reaction chamber. In some embodiments, the circulation path is disposed outside the reaction chamber.

In some embodiments, the compact plasma-based fusion neutron source includes a field-reversed-configuration (FRC) neutron source configured to produce an FRC plasma and generate the neutron flux from the FRC plasma.

In accordance with another aspect, there is provided a method for radionuclide production, the method including:
generating a neutron flux using a compact plasma-based fusion neutron source; and
exposing a target including neutron-activatable nuclides to the neutron flux to produce radionuclides through neutron activation of the neutron-activatable nuclides.

In some embodiments, the produced radionuclides include ⁹⁹Mo. In some embodiments, the neutron-activatable nuclides include ⁹⁸Mo, and ⁹⁹Mo is produced from ⁹⁸Mo through the reaction ⁹⁸Mo(n,γ)⁹⁹Mo, where n stands for a neutron and γ stands for a gamma particle. In some embodiments, the target includes MoO₃ dissolved in a solution. In some embodiments, the neutron-activatable nuclides include ¹⁰⁰Mo, and ⁹⁹Mo is produced from ¹⁰⁰Mo through the reaction ¹⁰⁰Mo(n,2n)⁹⁹Mo, wherein n stands for a neutron.

In some embodiments, the produced radionuclides include a single type of radionuclides. In some embodiments, the produced radionuclides include multiple types of radionuclides.

In some embodiments, the target may be provided as a slurry or mixture containing the neutron-activatable nuclides. For example, in the case of ⁹⁸Mo(n,γ)⁹⁹Mo production, the slurry or mixture may be produced from natural molybdenum (24.29% abundance of ⁹⁸Mo) in the form of molybdenum trioxide (MoO₃) powder by diluting the MoO₃ powder in sodium hydroxide (NaOH).

In some embodiments, the method further includes maintaining the target stationary with respect to the neutron flux during exposure of the target to the neutron flux. In some embodiments, the method further includes moving the target with respect to the neutron flux during exposure of the target to the neutron flux.

In some embodiments, moving the target with respect to the neutron flux includes circulating a flow of the target along at least one conduit exposed to the neutron flux, each conduit including a conduit inlet configured to receive the flow of the target prior to exposure of the target to the neutron flux and a conduit outlet configured to discharge the flow of the target after exposure of the target to the neutron flux. In some embodiments, moving the target with respect to the neutron flux includes: providing at least one conduit arranged for irradiation by the neutron flux, each conduit including a conduit inlet and a conduit outlet; supplying, through the conduit inlet, a flow of the target into the at least one conduit prior to exposing the target to the neutron flux; circulating the flow of the target along the at least one conduit while exposing the target to the neutron flux; and discharging, through the conduit outlet, the flow of the target from the at least one conduit after exposing the target to the neutron flux. In some embodiments, the at least one conduit includes a helical pattern.

In some embodiments, the at least one conduit includes a single conduit.

In some embodiments, the at least one conduit includes a plurality of conduits. In some embodiments, the plurality of conduits includes a first conduit and a second conduit, and circulating the flow of the target includes circulating a first flow of the target along the first conduit and circulating a second flow of the target along the second conduit, the first flow of the target includes a first type of neutron activatable nuclides and the second flow of the target includes a second type of neutron activatable nuclides different from the first type of neutron activatable nuclides. In some embodiments, the neutron-activatable nuclides of the first type include ⁹⁸Mo, from which ⁹⁹Mo is produced as a first type of radionuclides through the reaction ⁹⁸Mo(n,γ)⁹⁹Mo, and wherein the neutron-activatable nuclides of the second type include ¹⁰⁰Mo, from which ⁹⁹Mo is produced as a second type of radionuclides through the reaction ¹⁰⁰Mo(n,2n)⁹⁹Mo.

In some embodiments, generating the neutron flux includes generating the neutron flux with an average neutron energy ranging from about 2 MeV to about 15 MeV.

In some embodiments, the method further includes moderating the neutron flux to reduce an average neutron energy of the neutron flux prior to the neutron flux reaching the target. In some embodiments, moderating the neutron flux includes reducing the average neutron energy of the neutron flux to within a range of about 0.025 eV to about 300 eV.

In some embodiments, the method further includes extracting the produced radionuclides from the exposed target. For example, in the case of ⁹⁸Mo(n,γ)⁹⁹Mo production, the produced ⁹⁹Mo can be extracted from the irradiated target, including non-activated ⁹⁸Mo, by various processes, such as solvent extraction processes.

In some embodiments, the method further includes recycling non-activated neutron-activatable nuclides from the exposed target for use in further production of radionuclides. For example, in the case of ⁹⁸Mo(n,γ)⁹⁹Mo production, the irradiated slurry containing non-activated ⁹⁸Mo can be reused for further ⁹⁹Mo production after extraction of the produced ⁹⁹Mo.

In some embodiments, the method further includes providing the compact plasma-based fusion neutron source as a Z-pinch-based neutron source including a reaction chamber having a Z-pinch axis, the Z-pinch-based neutron source being configured to form a Z-pinch plasma along the Z-pinch axis inside the reaction chamber and generate the neutron flux from the Z-pinch plasma.

In some embodiments, the step of generating the neutron flux includes forming and sustaining a sheared-flow-stabilized Z-pinch plasma at fusion conditions—that is, at plasma temperature and density conditions at which fusion reactions occur inside the Z-pinch plasma-so as to allow the sheared-flow-stabilized Z-pinch plasma to generate the neutron flux during at least a portion of the Z-pinch lifetime.

In some embodiments, the method further includes providing the Z-pinch-based neutron source with a plasma confinement device including the reaction chamber, an inner electrode, and an outer electrode surrounding the inner electrode to define therebetween an acceleration region of the reaction chamber, the outer electrode extending axially beyond the inner electrode along the Z-pinch axis to define an assembly region of the reaction chamber adjacent the acceleration region, and generating the neutron flux includes: forming a precursor plasma outside the reaction chamber; introducing the precursor plasma into an acceleration region; and supplying power to the plasma confinement device to apply a voltage between the inner electrode and the outer electrode configured to cause the precursor plasma to flow along the acceleration region and into the assembly region and to be compressed into the Z-pinch plasma along the Z-pinch axis in the assembly region. In some embodiments, forming the precursor plasma includes supplying a process gas into a plasma formation region of a plasma generator, and supplying power to the plasma generator to apply a voltage across the plasma formation region configured to energize the process gas into the precursor plasma; and introducing the precursor plasma into the acceleration region includes flowing the precursor plasma from the plasma formation region to the acceleration region.

In some embodiments, the method further includes providing the Z-pinch-based neutron source with a plasma confinement device including the reaction chamber, an inner electrode, and an outer electrode surrounding the inner electrode to define therebetween an acceleration region of the reaction chamber, the outer electrode extending axially beyond the inner electrode along the Z-pinch axis to define an assembly region of the reaction chamber adjacent the acceleration region, and generating the neutron flux includes supplying a precursor gas inside acceleration region, supplying power to the plasma confinement device to apply a voltage between the inner electrode and the outer electrode configured to energize the precursor gas into a precursor plasma and cause the precursor plasma to flow along the acceleration region and into the assembly region and to be compressed into the Z-pinch plasma along the Z-pinch axis in the assembly region.

In some embodiments, the Z-pinch-based neutron source is configured to form the Z-pinch plasma with an embedded radially sheared axial flow.

In some embodiments, the method further includes disposing the target radially outside and at least partially circumferentially around the assembly region. In some embodiments, the method further includes flowing the target along a circulation path extending helically around the Z-pinch axis over an axial portion of the assembly region. In some embodiments, the method further includes disposing the circulation path radially outwardly of the outer electrode. In some embodiments, the method further includes disposing the circulation path radially inside the outer electrode.

In some embodiments, the method further includes providing the Z-pinch-based neutron source with a plasma confinement device including the reaction chamber, a first compression electrode disposed at a first end of the reaction chamber, and a second compression electrode disposed at a second end of the reaction chamber spaced apart from the first end along the Z-pinch axis, and generating the neutron flux includes: supplying, through an inner injector, an inner precursor medium into the reaction chamber; supplying, through an outer injector disposed radially outwardly of the inner injector with respect to the Z-pinch axis, an outer precursor plasma into the reaction chamber at an outer velocity; and supplying power to the plasma confinement device to apply a voltage between the first compression electrode and the second compression electrode configured to energize and compress the inner precursor medium and the outer precursor plasma into the Z-pinch plasma with a radially sheared axial flow. In some embodiments, supplying the inner precursor medium into the reaction chamber includes supplying, as the inner precursor medium, an inner precursor plasma into the reaction chamber at an inner velocity different from the outer velocity of the outer precursor plasma. In some embodiments, supplying the inner precursor medium into the reaction chamber includes supplying, as the inner precursor medium, an inner precursor gas into the reaction chamber.

In some embodiments, the method further includes flowing the target along a circulation path extending helically around the Z-pinch axis over an axial portion of the reaction chamber. In some embodiments, the method further includes disposing the circulation path outside the reaction chamber.

In some embodiments, the method further includes providing the compact plasma-based fusion neutron source as a field-reversed-configuration (FRC) neutron source configured to produce an FRC plasma and generate the neutron flux from the FRC plasma.

In some embodiments, the target moves during neutron irradiation and radionuclide production. In some embodiments, the method may include a step of circulating the target with respect to the neutron flux. For example, the method may include a step of producing a Z-pinch plasma extending along a Z-pinch axis and from which the neutron flux emanates, and a step of circulating the target, which may be provided as a slurry or another form of flowable material or mixture, along a circulation path extending around and spaced outwardly from the Z-pinch axis. Depending on the application, the circulation path may include less than one, one, or multiple turns around the Z-pinch axis. For example, the circulation path may extend in a helical manner around the Z-pinch axis. In some embodiments, the circulation path may be provided as a conduit (e.g., a pipe, tube, or any suitable enclosed channel) wrapped around the Z-pinch axis and extending between a conduit inlet configured to receive the target prior to neutron irradiation and radionuclide production and a conduit outlet configured to discharge the target after neutron irradiation and radionuclide production. For example, in some embodiments where the Z-pinch-based neutron source includes an inner electrode and an outer electrode defining an acceleration region and an assembly region, the conduit may be disposed outside the outer electrode and wrapped at least partially circumferentially around the assembly region, where the Z-pinch plasma is produced and from which the neutron flux is generated. In some embodiments, the circulation path may include a single conduit. In other embodiments, the circulation path may include a plurality of conduits, each having its own conduit inlet and conduit outlet, and each being configured to circulate therein a respective portion of the target. Depending on the application, the different portions of the target circulating in the different conduits may or may not contain the same type of neutron-activatable nuclides. It is appreciated that by circulating target portions containing different types of neutron-activatable nuclides in different conduits, and by exposing the different neutron-activatable nuclides to the neutron flux generated by the Z-pinch-based neutron source, the present techniques can allow for the concurrent production of different types of radionuclides, or the concurrent production of the same type of radionuclides using different reaction routes (e.g., ⁹⁹Mo(n,γ)⁹⁹Mo production in a first conduit or set of conduits and ¹⁰⁰Mo(n,2n)⁹⁹Mo production in a second conduit or set of conduits).

In some embodiments, the system includes a neutron moderator interposed in a path of the neutron flux between the Z-pinch plasma and the target and configured to thermalize the neutron flux prior to the neutron flux reaching the target. In some embodiments, the neutron moderator may include one or more layers or sheets disposed around the Z-pinch axis, radially outwardly of the Z-pinch-based neutron source and radially inwardly of the target holder.

In some embodiments, the radionuclide production system further includes a control and processing device operatively coupled at least to the compact plasma-based fusion neutron source and the target holder, the control and processing device including a processor and a non-transitory computer readable storage medium having stored thereon computer readable instructions that, when executed by the processor, cause the processor to perform operations, the operations including controlling the compact plasma-based fusion neutron source to generate the neutron flux and controlling the target holder to expose a target comprising neutron-activatable nuclides to the neutron flux to produce radionuclides through neutron activation of the neutron-activatable nuclides.

Non-limiting possible advantages and benefits associated with some embodiments disclosed herein include one or more of the following: reduced operating costs, improved compactness and scalability of design, reduced regulatory burden and security issues, simpler post-processing and reduced waste generation, and possibility of installation closer to the point of use.

Other method and process steps may be performed prior, during, or after the steps described herein. The order of one or more steps may also differ, and some of the steps may be omitted, repeated, and/or combined, as the case may be.

Other objects, features, and advantages of the present description will become more apparent upon reading of the following non-restrictive description of specific embodiments thereof, given by way of example only with reference to the appended drawings. Although specific features described in the above summary and in the detailed description below may be described with respect to specific embodiments or aspects, it should be noted that these specific features may be combined with one another unless stated otherwise.

### BRIEF DESCRIPTION OF THE DRAWINGS

FIG. 1 is a flow diagram of a method for producing radionuclides, in accordance with an embodiment.

FIG. 2 is schematic perspective view of radionuclide production system, in accordance with an embodiment.

FIG. 3 is a schematic longitudinal cross-sectional view of the radionuclide production system of FIG. 2, taken along section line 3-3 in FIG. 2.

FIGS. 4A to 4E depict five different stages of a method of operating a radionuclide production system to produce a neutron-generating Z-pinch plasma, in accordance with another embodiment.

FIG. 5 is a schematic longitudinal cross-sectional view of a radionuclide production system, in accordance with an embodiment.

FIG. 6 is a schematic longitudinal cross-sectional view of a radionuclide production system, in accordance with an embodiment.

FIG. 7 is schematic perspective view of radionuclide production system, in accordance with another embodiment.

FIG. 8 is schematic perspective view of radionuclide production system, in accordance with another embodiment.

FIG. 9 is a schematic longitudinal cross-sectional view of a radionuclide production system, in accordance with another embodiment.

FIG. 10 is a schematic longitudinal cross-sectional view of a radionuclide production system, in accordance with another embodiment.

FIG. 11 is a schematic longitudinal cross-sectional view of a radionuclide production system, in accordance with another embodiment.

FIG. 12 is a schematic longitudinal cross-sectional view of a radionuclide production system, in accordance with another embodiment.

FIG. 13 is a schematic longitudinal cross-sectional view of a radionuclide production system, in accordance with another embodiment.

### DETAILED DESCRIPTION

In the present description, similar features in the drawings have been given similar reference numerals. To avoid cluttering certain figures, some elements may not be indicated if they were already identified in a preceding figure. The elements of the drawings are not necessarily depicted to scale, since emphasis is placed on clearly illustrating the elements and structures of the present embodiments. Furthermore, positional descriptors indicating the location and/or orientation of one element with respect to another element are used herein for ease and clarity of description. Unless otherwise indicated, these positional descriptors should be taken in the context of the figures and should not be considered limiting. Such spatially relative terms are intended to encompass different orientations in the use or operation of the present embodiments, in addition to the orientations exemplified in the figures. Furthermore, when a first element is referred to as being “on”, “above”, “below”, “over”, or “under” a second element, the first element can be either directly or indirectly on, above, below, over, or under the second element, respectively, such that one or multiple intervening elements may be disposed between the first element and the second element.

The terms “a”, “an”, and “one” are defined herein to mean “at least one”, that is, these terms do not exclude a plural number of elements, unless stated otherwise.

The term “or” is defined herein to mean “and/or”, unless stated otherwise.

The expressions “at least one of X, Y, and Z” and “one or more of X, Y, and Z”, and variants thereof, are understood to include X alone, Y alone, and Z alone, as well as any combination of X, Y, and Z.

Terms such as “substantially”, “generally”, and “about”, which modify a value, condition, or characteristic of a feature of an exemplary embodiment, should be understood to mean that the value, condition, or characteristic is defined within tolerances that are acceptable for the proper operation of this exemplary embodiment for its intended application or that fall within an acceptable range of experimental error. In particular, the term “about” generally refers to a range of numbers that one skilled in the art would consider equivalent to the stated value (e.g., having the same or an equivalent function or result). In some instances, the term “about” means a variation of 10% of the stated value. It is noted that all numeric values used herein are assumed to be modified by the term “about”, unless stated otherwise. The term “between” as used herein to refer to a range of numbers or values defined by endpoints is intended to include both endpoints, unless stated otherwise.

The term “based on” as used herein is intended to mean “based at least in part on”, whether directly or indirectly, and to encompass both “based solely on” and “based partly on”. In particular, the term “based on” may also be understood as meaning “depending on”, “representative of”, “indicative of”, “associated with”, “relating to”, and the like.

The terms “match”, “matching”, and “matched” refer herein to a condition in which two elements are either the same or within some predetermined tolerance of each other. That is, these terms are meant to encompass not only “exactly” or “identically” matching the two elements, but also “substantially”, “approximately”, or “subjectively” matching the two elements, as well as providing a higher or best match among a plurality of matching possibilities.

The terms “connected” and “coupled”, and derivatives and variants thereof, refer herein to any connection or coupling, either direct or indirect, between two or more elements, unless stated otherwise. For example, the connection or coupling between elements may be mechanical, optical, electrical, magnetic, thermal, chemical, logical, fluidic, operational, or any combination thereof.

The term “concurrently” refers herein to two or more processes that occur during coincident or overlapping time periods. The term “concurrently” does not necessarily imply complete synchronicity and encompasses various scenarios including time-coincident or simultaneous occurrence of two processes; occurrence of a first process that both begins and ends during the duration of a second process; and occurrence of a first process that begins during the duration of a second process, but ends after the completion of the second process.

The present description generally relates to methods and systems for use in radionuclide production by neutron activation using a compact plasma-based fusion neutron source, for example, a Z-pinch-based neutron source, an FRC-based neutron source, a dense plasma focus (DPF) neutron source, or another suitable compact plasma source. In some embodiments, the method can include a step of generating a flux of neutrons from a Z-pinch plasma produced by a Z-pinch-based neutron source, and a step of irradiating a target containing neutron-activatable nuclides with the flux of neutron to produce radionuclides through neutron activation of the neutron-activatable nuclides.

In some embodiments, the term “compact” can refer to plasma-based fusion neutron sources of lower power output levels (e.g., in the order of 1 to 100 MW) and neutron production rates (e.g., in the order of 10⁸ to 10²⁰ neutrons per second), when compared to larger sources, such as ITER and other tokamak fusion reactors, with power output levels in the order of GW and neutron production rates in the order of 10²¹ neutrons per second. However, this definition is not intended to be limiting as other definitions of the term “compact” can be used to refer to smaller-scale plasma-based fusion neutron sources. For example, in some applications, the term “compact” can refer to plasma-based fusion neutron sources whose size and weight are markedly less (e.g., less than 5%) than the size and weight of the ITER fusion reactor.

The term “radionuclide” refers herein to a nuclear species of natural or artificial origin having an unstable nucleus that tends to undergo radioactive decay. Non-limiting examples of radioactive decay modes include, to name a few, alpha decay, beta decay, gamma decay, proton emission, neutron emission, electron capture, and spontaneous fission. Non-limiting examples of radionuclides that may be produced by neutron activation include, to name a few, ⁹⁹Mo, ²²⁵Ac, ²?Ac, ¹¹⁹Te, ⁶⁴Cu, ⁶⁷Cu, ³²P, ⁴⁷Sc, ¹⁵³Sm, ¹⁷Lu, ¹⁸⁶Re, ⁷⁵Se, ¹⁰³Pd, ¹⁹²Ir, ¹⁰⁹Cd, ³H, ¹⁴C, ⁵¹Cr, ⁵²Fe, ⁵⁹Fe, ⁶⁰Co, ⁸⁹Sr, ⁹⁰Y, ¹¹³Sn, ¹²⁴Xe, ³⁰Te, and ¹⁶⁶Ho. The radionuclides produced by the present techniques may be used in nuclear medicine applications, or in any other suitable industrial and research applications.

Nuclear fusion energy is energy produced by a nuclear fusion process in which two or more lighter atomic nuclei are joined to form a heavier nucleus whose mass is less than the sum of the masses of the lighter nuclei. The difference in mass is released as energy, notably in the form of neutrons. Common examples of thermonuclear fusion reactions are the deuterium-tritium (D-T) reaction, which generates 14.06-MeV neutrons, and the deuterium-deuterium (D-D) reaction, which generates 2.45-MeV neutrons. Fusion reactors are devices whose function is to harness fusion energy. One type of fusion reactors relies on magnetic plasma confinement. Such fusion reactors aim to confine high-temperature plasmas to sufficiently high-density with prolonged stability. Different types of configurations for magnetic plasma confinement have been devised and studied over the years. Non-limiting examples include Z-pinch-configurations, magnetic mirror configurations, FRC configurations, and toroidal configurations, for example, the tokamak and the stellarator.

In Z-pinch configurations, a plasma column with an axial current flowing through it generates an azimuthal magnetic field that exerts an inward magnetic pressure and an inward magnetic tension that radially compress the plasma against the outward plasma pressure until an equilibrium is established and a Z-pinch plasma is formed. By increasing the axial current to compress the Z-pinch plasma to sufficiently high plasma density and temperature, fusion reactions can be achieved, resulting in an exothermic energy release. In many applications, fusion reactions release their energy in the form of neutrons, for example, via the D-T or D-D reactions. Being chargeless, neutrons can escape from the magnetically confined plasma and transfer their kinetic energy into thermal energy after they exit the plasma confinement region. This thermal energy can be converted into electricity, for example, by transferring the heat generated to a working fluid used by a heat engine for generating electrical energy. In the present techniques, the neutron flux generated from the Z-pinch plasma is used for neutron-activation-based radionuclide production.

Z-pinch reactors are attractive due to their simple geometry, absence of magnetic field coils for plasma confinement and stabilization, inherent compactness, and relatively low cost. Conventional Z-pinches are generally unstable due to the presence of magnetohydrodynamic (MHD) instabilities. A challenge in Z-pinch fusion research is devising ways of improving the control of instabilities to keep Z-pinch plasmas confined long enough to sustain ongoing fusion reactions. This is because once the reaction becomes unstable, the pinch ceases and neutron production stops. Techniques such as close fitting walls, axial magnetic fields, and pressure profile control have been proposed, with mitigated results. Recent advances have demonstrated that sheared-flow-stabilized Z-pinches—that is, Z-pinches with a radially sheared axial velocity—can provide a promising stabilization approach to achieving and sustaining fusion-based neutron production. It is appreciated that the theory, configuration, implementation, and operation of sheared-flow-stabilized Z-pinch plasma confinement devices in nuclear fusion applications are generally known in the art and need not be described in detail herein other than to facilitate an understanding of the present techniques. Reference is made in this regard to international patent application PCT/US2018/019364 (published as WO 2018/156860), Y. Zhang et al. “Sustained Neutron Production from a Sheared-Flow Stabilized Z Pinch” Phys. Rev. Lett. 122, 135,001, (2019), and the following doctoral dissertation: Golingo, Raymond, Formation of a Sheared Flow Z-Pinch (University of Washington, 2003). The contents of these three documents are incorporated herein by reference in their entirety.

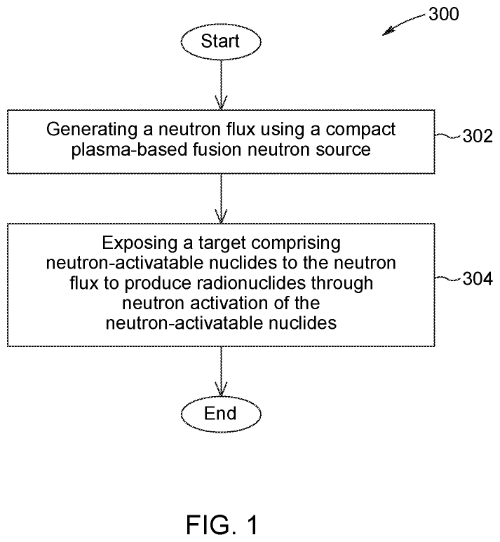

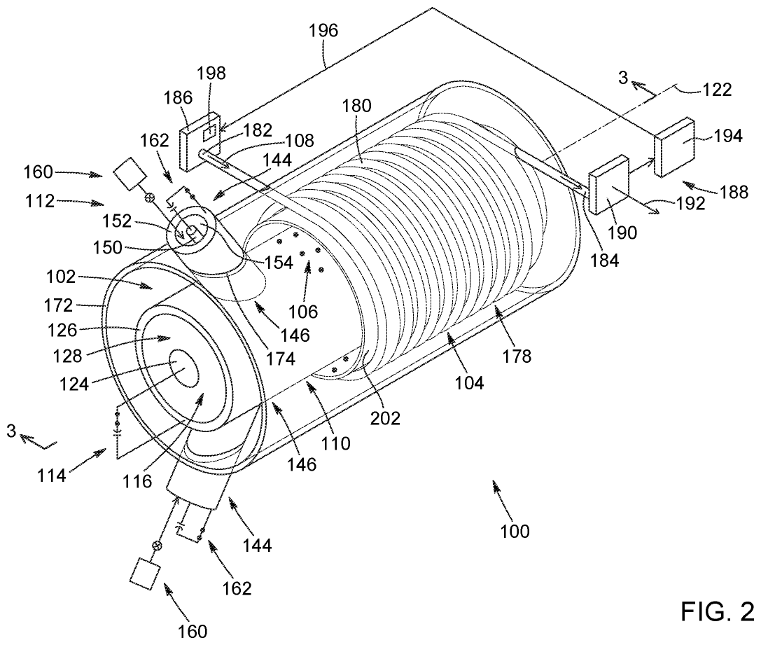

Referring to FIG. 1, there is illustrated a flow diagram of a method 300 for radionuclide production, in accordance with an embodiment. The method 300 of FIG. 1 may be implemented in a radionuclide production system 100 such as the ones depicted in FIGS. 2 to 13, or another suitable radionuclide production system. The method 300 of FIG. 1 includes a step 302 of generating a neutron flux using a compact plasma-based fusion neutron source, and a step 304 of exposing a target including neutron-activatable nuclides to the neutron flux to produce radionuclides through neutron activation of the neutron-activatable nuclides. More detail regarding these steps and other possible of the radionuclide production method 300 are provided below.

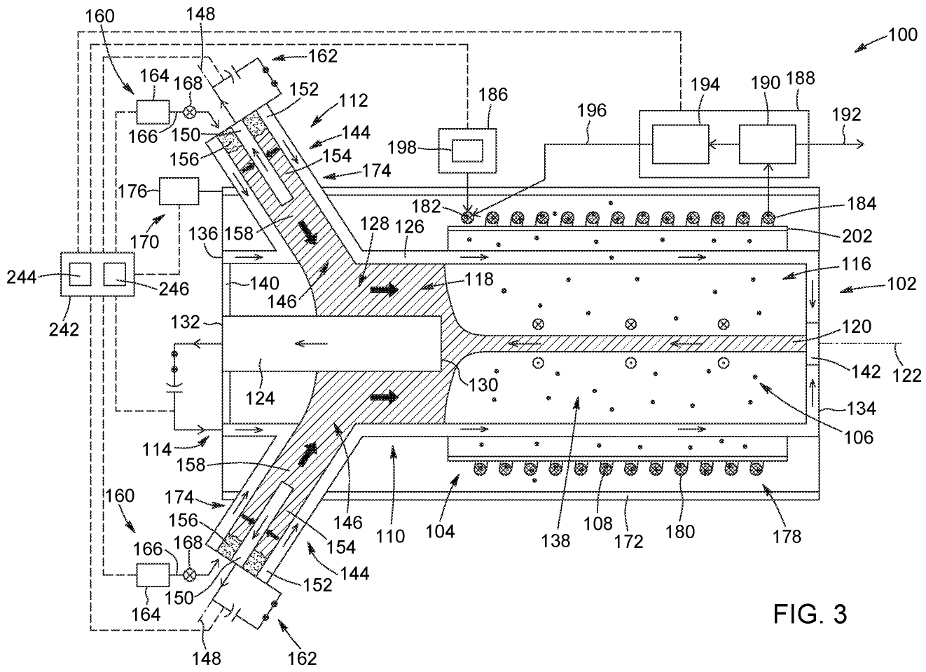

Referring to FIGS. 2 and 3, there are illustrated schematic views of a system 100 for production of radionuclides, in accordance with an embodiment. It is noted that certain components of the system 100 that are depicted in FIG. 3 have been entirely or partially omitted in FIG. 2 for clarity and ease of illustration. The system 100 generally includes a compact plasma-based fusion neutron source 102 and a target holder 104. The compact plasma-based fusion neutron source 102 is configured to generate a neutron flux 106. The target holder 104 configured to hold a target 108 including neutron-activatable nuclides. The target holder 104 is arranged with respect to the compact plasma-based fusion neutron source 102 to expose the target 108 to the neutron flux 106 and produce radionuclides through neutron activation of the neutron-activatable nuclides.

In the illustrated embodiment, the compact plasma-based fusion neutron source 102 is a Z-pinch-based neutron source, but other types of compact plasma-based fusion neutron sources can be used in other embodiments. The term “Z-pinch plasma” broadly refers herein to a plasma that has an electric current flowing substantially along the longitudinal or axial direction Z of a cylindrical coordinate system. The axial electrical current generates an azimuthal magnetic field that radially compresses, or pinches, the plasma by the Lorentz force. It is appreciated that in some instances, terms such as “Z-pinch”, “zeta pinch”, “plasma pinch”, “pinch”, “plasma arc” may be used interchangeably with the term “Z-pinch plasma”.

The Z-pinch-based neutron source 102 in FIGS. 2 and 3 generally includes a plasma confinement device 110, a plasma formation and injection device 112, and a main power supply 114. The plasma confinement device 110 includes a reaction chamber 116. The plasma formation and injection device 112 is coupled to, but disposed externally of, the reaction chamber 116 of the plasma confinement device 110. The plasma formation and injection device 112 is configured to form a precursor plasma 118 outside the reaction chamber 116 and to introduce, inject, or otherwise couple the precursor plasma 118 inside the reaction chamber 116. The main power supply 114 is configured to supply electric power to the plasma confinement device 110 to apply a voltage across the reaction chamber 116 to cause the precursor plasma 118 to be compressed to form and sustain a Z-pinch plasma 120 along a Z-pinch axis 122 of the reaction chamber 116. The Z-pinch-based neutron source 102 is configured to compress and heat the Z-pinch plasma 120 sufficiently to reach fusion conditions, that is, plasma density and temperature conditions at which fusion reactions occur inside the Z-pinch plasma 120, including neutronic fusion reactions that produce neutrons, which are emitted from the Z-pinch plasma 120 as the outwardly directed neutron flux 106. In some embodiments, the Z-pinch-based neutron source 102 is configured to produce the Z-pinch plasma 120 with an embedded radially sheared axial velocity flow. The target holder 104 is arranged with respect to the Z-pinch-based neutron source 102 to expose the target 108 to the neutron flux 106 emanating from the Z-pinch plasma 120, thereby producing radionuclides by neutron activation of the neutron-activatable nuclides.

Depending on the application, the radionuclides produced by the system 100 can include a single type of radionuclides or multiple types of radionuclides. In some embodiments, the produced radionuclides may include ⁹⁹Mo. In such embodiments, the neutron-activatable nuclides can include ⁹⁸Mo, in which case ⁹⁹Mo can be produced by neutron capture through the reaction ⁹⁸Mo(n,γ)⁹⁹Mo, where n stands for a neutron and γ stands for a gamma particle. In other embodiments, the neutron-activatable nuclides can include ¹⁰⁰Mo, in which case ⁹⁹Mo can be produced by neutron capture through the reaction ⁹⁸Mo(n,2n)⁹⁹Mo. In yet other embodiments, the neutron-activatable nuclides can include both ⁹⁸Mo and ¹⁰Mo, in which case ⁹⁹Mo can be produced through both the ⁹⁸Mo(n,γ)⁹⁹Mo reaction and the ¹⁰⁰Mo(n,2n)⁹⁹Mo reaction. In still further embodiments, other radionuclides may be produced in addition to, or instead of, ⁹⁹Mo. Non-limiting examples of other types of radionuclides include, to name a few, ²²Ac, ²²⁷Ac, ¹¹⁹Te, ⁶⁴Cu, ⁶⁷Cu, ³²P, ⁴⁷Sc, ¹⁵³Sm, ¹⁷⁷Lu, ¹⁸⁶Re, ⁷⁵Se, ¹⁰³Pd, ¹⁹²Ir, ¹⁰⁹Cd, and ¹⁶⁶Ho.

The structure, configuration, and operation of these and other possible components of the radionuclide production system 100 are described in greater detail below It is appreciated that FIGS. 2 and 3 are simplified schematic representations that illustrate certain features and components of the radionuclide production system 100, such that additional features and components that may be useful or necessary for its practical operation may not be specifically depicted. Non-limiting examples of such additional features and components can include, to name a few, power supplies, electrical connections, gas sources, gas supply lines (e.g., conduits, such as pipes or tubes), pressure and flow control devices (e.g., pumps, valves, regulators, restrictors), operation monitoring and diagnostic devices (e.g., sensors), processors and controllers, and other standard hardware and equipment. It is also appreciated that the configuration and operation of the Z-pinch-based neutron source 102 illustrated in FIGS. 2 and 3 is similar to the configuration and operation of Z-pinch plasma processing systems disclosed in co-assigned International Patent Application No. PCT/US2021/062830, filed on Dec. 10, 2021, the contents of which are incorporated herein by reference in their entirety.

The plasma confinement device 110 includes an inner electrode 124 and an outer electrode 126 surrounding the inner electrode 124 to define a plasma acceleration region 128 therebetween. In the illustrated embodiment, the inner electrode 124 and the outer electrode 126 each have an elongated configuration along the Z-pinch axis 122. The inner electrode 124 has a front end 130 and a rear end 132, and the outer electrode 126 has a front end 134 and a rear end 136. The outer electrode 126 extends forwardly beyond the inner electrode 124 along the Z-pinch axis 122 to define a pinch assembly region 138 adjacent the acceleration region 128. The volume occupied by the acceleration region 128 and the assembly region 138 defines the reaction chamber 116 of the plasma confinement device 110.

In the illustrated arrangement, the inner electrode 124 and the outer electrode 126 both have a substantially cylindrical configuration, with a circular cross-section transverse to the Z-pinch axis 122, and the outer electrode 126 encloses the inner electrode 124 in a coaxial arrangement with respect to the Z-pinch axis 122. However, various other electrode configurations may be used in other embodiments. Non-limiting examples include, to name a few, non-coaxial arrangements, non-circularly symmetric transverse cross-sections, three-electrode arrangements, and the like. In some embodiments, the inner electrode 124 may have a length ranging from about 25 cm to about one or a few meters and a radius ranging from about 2 cm to about 1 mm, while the outer electrode 126 may have a length ranging from about 50 cm to about 6 m, a radius ranging from about 6 cm to about 2 m or more, and a wall thickness ranging from about 6 mm to about 12 mm, although other electrode dimensions may be used in other embodiments. Depending on the application, the inner electrode may have a full or hollow configuration. The inner electrode 124 and the outer electrode 126 may each be made of any suitable electrically conductive material, such as various metals and metal alloys. Non-limiting examples include, to name a few, tungsten-coated copper and graphite. It is appreciated that the size, shape, composition, structure, and arrangement of the inner electrode 124 and the outer electrode 126 can be varied depending on the application.

The plasma confinement device 110 can also include an electrode insulator 140 disposed between the inner electrode 124 and the outer electrode 126. The electrode insulator 140 is configured to provide electrical insulation between the inner electrode 124 and the outer electrode 126 so as to prevent or help prevent unwanted charge buildup and other undesirable electrical phenomena that could adversely affect the operation of the plasma confinement device 110. In the illustrated embodiment, the electrode insulator 140 has an annular cross-sectional shape and is disposed near the rear ends 132, 136 of the inner and outer electrodes 124, 126. The electrode insulator 140 may be made of any suitable electrically insulating material, for example, glass, ceramic, and glass-ceramic materials.

In the illustrated embodiment, the acceleration region 128 has a substantially annular cross-sectional shape defined by the cross-sectional shapes of the inner and outer electrodes 124, 126. The acceleration region 128 is configured to receive the precursor plasma 118 from the plasma formation and injection device 112 and allow the precursor plasma 118 to flow along the acceleration region 128 and into the assembly region 138. In some embodiments, the acceleration region 128 may have a length ranging from about 25 cm to about 1.5 m and an annular thickness from about 2 cm to about 10 cm, although other dimensions may be used in other embodiments.

In the illustrated embodiment, the assembly region 138 has a substantially circular cross-sectional shape defined by the cross-sectional shape of the portion of the outer electrode 126 that projects axially beyond the inner electrode 124. The assembly region 138 generally extends between the front end 130 of the inner electrode 124 and the front end 134 of the outer electrode 126. In the illustrated embodiment, the front end 130 of the inner electrode 124 is flat, and the front end 134 of the outer electrode 126 defines a front end wall of the plasma confinement device 110. However, non-flat geometries (e.g., half-spherical, conical, tapered, either concave or convex) for the front end 130 of the inner electrode 124 and/or the front end 134 of the outer electrode 126 are possible in other embodiments. The assembly region 138 is configured to sustain the Z-pinch plasma 120 along the Z-pinch axis 122 between the front end 130 of the inner electrode 124 and the front end 134 of the outer electrode 126. In some embodiments, the assembly region 138 may have a length ranging from about 25 cm to about 3 in or more, although other dimensions may be used in other embodiments. In some embodiments, the plasma confinement device 110 may include a plasma exit port 142 configured to allow part of the Z-pinch plasma 120 to exit the plasma confinement device 110, so as to avoid a stagnation point in the plasma flow that could create instabilities and destroy the Z-pinch plasma 120. In the illustrated embodiment, the plasma exit port 142 is provided as a hole formed on the Z-pinch axis 122 at a front end wall of the outer electrode 126. In other embodiments, the plasma exit port 142 may provided at other locations of the plasma confinement device 110, for example, through the peripheral wall of the outer electrode 126. In yet other embodiments, a plurality of plasma exit ports may be provided.

Referring still to FIGS. 2 and 3, the main power supply 114 is connected to the inner electrode 124 and the outer electrode 126 via appropriate electrical connections. The term “power supply” refers herein to any device or combination of devices configured to supply electrical power into a form usable by another device or combination of devices. It is appreciated that while the main power supply 114 depicted as a single entity for illustrative purposes, the term “power supply” should not be construed as being limited to a single power supply and, accordingly, in some embodiments the main power supply 114 may include a plurality of power supply units.

In some embodiments, the main power supply 114 may be a switching pulsed-DC power supply and may include an energy source (e.g., a capacitor bank, such as in FIGS. 2 and 3), a switch (e.g., a spark gap, an ignitron, or a semiconductor switch), and a pulse shaping network (including, e.g., inductors, resistors, diodes, and the like). Depending on the application, the main power supply 114 may be voltage-controlled or current-controlled. Other suitable types of power supplies may be used in other embodiments, including DC and AC power supplies. Non-limiting examples include, to name a few, DC grids, voltage source converters, and homopolar generators. The main power supply 114 is configured to supply power to the plasma confinement device 110 in order to a apply voltage between the inner electrode 124 and the outer electrodes 126. The voltage is configured to generate an accelerating electric field in the acceleration region 128 that causes the precursor plasma 118 to flow along the acceleration region 128 and into the assembly region 138 and to be compressed into the Z-pinch plasma 120 along the Z-pinch axis 122 in the assembly region 138.

In some embodiments, the voltage applied between the inner and outer electrodes 124, 126 may range from about 1 kV to about 40 kV, although other voltage values may be used in other embodiments. In some embodiments, the voltage may be applied as a voltage pulse of duration ranging from 100 μm to about 1 to 10 ms, although other pulse duration values may be used in other embodiments. The operation of the main power supply 114 may be selected in view of the parameters of the precursor plasma 118 injected within the acceleration region 128 and the configuration and operating conditions of the plasma confinement device 110 in order to favor the compression of the precursor plasma 118 into the Z-pinch plasma 120 in a regime of sustained neutron production. Depending on the application, the operation of introducing the precursor plasma 118 into the acceleration region 128 can be initiated before, at the same time as, or after initiating the operation of activating the main power supply 114 to apply the voltage between the inner electrode 124 and the outer electrode 126.

Referring still to FIGS. 2 and 3, the plasma formation and injection device 112 is disposed outside the reaction chamber 116 of the plasma confinement device 110, that is, outside both the acceleration region 128 and the assembly region 138. The plasma formation and injection device 112 is configured to form the precursor plasma 118 outside the reaction chamber 116 and to inject the precursor plasma 117 inside the reaction chamber 116, more specifically inside the acceleration region 128.

In some embodiments, the precursor plasma 118 may have the following properties and parameters: an electron temperature ranging from about 1 eV to about 100 eV, an ion temperature ranging from about 1 eV to about 100 eV, an electron density ranging from about 10¹³ cm⁻³ to about 10⁶ cm⁻³, an ion density ranging from about 10¹³ cm⁻³ to about 10¹⁶ cm⁻³, and a degree of ionization ranging from about 50% to about 100%. Depending on the application, the precursor plasma 118 may be magnetized or unmagnetized.

In FIGS. 2 and 3, the plasma formation and injection device 112 includes two distinct plasma generators or sources 144 and two respective plasma injectors or couplers 146, so that each generator-injector unit contributes a respective portion of the precursor plasma 118 injected into the acceleration region 128 of the plasma confinement device 110. In other embodiments, the plasma formation and injection device 112 m plasma generator(s) 144 and n plasma injector(s) 146, where m and n are any suitable positive numbers, and where m and n may or may not be identical to each other.

It is appreciated that many plasma formation and generation techniques exist, notably in fusion generation applications, and may be used in the embodiments disclosed herein to form the precursor plasma 118 with desired or required properties. In particular, the theory, instrumentation, implementation, and operation of plasma sources and are generally known in the art and need not be described in detail herein other than to facilitate an understanding of the present techniques.

In FIGS. 2 and 3, each of the two plasma generators 144 of the plasma formation and injection device 112 is configured as a coaxial plasma gun. However, other types of electromagnetic plasma generators can be used in other embodiments. Coaxial plasma guns and other electromagnetic plasma generators generally operate by using the electric field generated by a high-voltage power supply to energize a gas into a plasma, and by relying on the Lorentz force to propel the plasma toward an outlet of the plasma gun. In the illustrated embodiment, each coaxial plasma generator 144 has a plasma formation axis 148 and includes an inner electrode 150 and an outer electrode 152 disposed around the inner electrode 150 in a coaxial arrangement with respect to the plasma formation axis 148. In addition, the outer electrode 152 projects axially beyond the inner electrode 150 and terminates at the plasma injector 146. In some embodiments, the inner electrode 150 may have a length ranging from about 75 mm to about 250 mm and a radius ranging from about 2 mm to about 7.5 mm, while the outer electrode 152 may have a length ranging from about 75 mm to about 275 mm, a radius ranging from about 12 mm to about 25 mm, and a wall thickness ranging from about 2.5 mm to about 7.5 mm, although other electrode dimensions may be used in other embodiments. The annular volume extending between the inner electrode 150 and the outer electrode 152 defines a plasma formation region 154 configured to receive a process gas 156 (e.g., a neutral gas or another plasma precursor gas) for the process gas 156 to be energized into the precursor plasma 118. The cylindrical volume surrounded by the outer electrode 152 and extending axially beyond the front end of the inner electrode 150 defines a plasma transport channel 158 of the plasma generator 144. The plasma transport channel 158 extends along the plasma formation axis 148 from the plasma formation region 154 to the plasma injector 146. It is appreciated that the plasma generators 144 may be operated as plasma deflagration guns and will generally not form the precursor plasma 118 as a plasma pinch.

The process gas 156 can be any suitable gas or gas mixture containing fusion reactants that can undergo neutronic fusion reactions when compressed into the Z-pinch plasma 120. Depending on the application, the process gas 156 can be a neutral gas or gas mixture, or a weakly ionized gas or gas mixture. In some embodiments, the process gas 156 may be deuterium gas (D-D reaction) or a gas mixture containing deuterium and tritium (D-T reaction). Other mixtures may include hydrogen or helium. The precursor plasma 118 may be formed by supplying the process gas 156 to the plasma formation region 154 and by applying a voltage between the inner and outer electrodes 150, 152 to ionize or otherwise energize the process gas 156 into the precursor plasma 118. For this purpose, each plasma generator 144 can include or be coupled to a process gas supply unit 160 and a plasma formation power supply 162. Depending on the application, the operation of introducing the process gas 156 into the plasma formation region 154 can be initiated before, at the same time as, or after initiating the operation of activating the plasma formation power supply 162 to apply the voltage between the inner electrode 150 and the outer electrode 152.

The process gas supply unit 160 is configured to supply the process gas 156 into the plasma formation region 154. The process gas supply unit 160 can include or be coupled to a process gas source 164 configured to store the process gas 156. The process gas source 164 may be embodied by a gas storage tank or any suitable pressurized gas dispensing container. The process gas supply unit 160 may also include a process gas supply line 166 (e.g., including gas conduits or channel) configured to convey the process gas 156 from the process gas source 164 to the plasma formation region 154 of each plasma generator 144. The process gas supply unit 160 may further include a process gas supply valve 168 or other flow control devices configured to control a flow of the process gas 156 along the process gas supply line 166, from the process gas source 164 to the plasma formation region 154 of each plasma generator 144. The process gas supply valve 168 may be embodied by a variety of electrically actuated valves, such as solenoid valves. Other flow control devices (not shown), such as pumps, regulators, and restrictors, may be provided to control the process gas flow rate and pressure along the process gas supply line 166. Various process gas injection configurations may be used depending on the application. For example, in some embodiments, a single process gas source may be configured to supply process gas to multiple plasma generators.

Referring still to FIGS. 2 and 3, the plasma formation power supplies 162 are distinct from the main power supply 114 coupled to the inner electrode 124 and the outer electrode 126 of the plasma confinement device 110. Depending on the application, the plasma formation power supplies 162 may or may not be identical to each other. Each plasma formation power supply 162 is connected to the inner electrode 150 and the outer electrode 152 of its corresponding plasma generator 144 via appropriate electrical connections. In the illustrated embodiment, each plasma formation power supply 162 includes a capacitor bank and a switch, although other suitable types of power supplies may be used in other embodiments (e.g., flywheel power supplies). Each plasma formation power supply 162 is configured to apply a voltage between the inner and outer electrodes 150, 152 to generate an ionizing electric field across the plasma formation region 154. The ionizing electric field is configured to ionize and break down the process gas 156, thereby forming into the precursor plasma 118. In some embodiments, the voltage applied between the inner and outer electrodes 150, 152 may range from about 750 V to about 5 kV, although other voltage values may be used in other embodiments. It is appreciated that the configuration and the operation of the plasma formation power supplies 162 may be adjusted to favor the breakdown of the process gas 156 and control the parameters of the precursor plasma 118. It is appreciated that in other embodiments, the plasma formation and injection device 112 may use other types of plasma sources and plasma formation techniques to form the precursor plasma 118. Non-limiting examples of such possible plasma sources include, to name a few, gas injected washer plasma guns; plasma thrusters, for example, Hall effect thrusters and MHD thrusters; if the precursor plasma 118 is magnetized, high-power helicon plasma sources; RF plasma sources; plasma torches; and laser-based plasma sources.

The portion of the precursor plasma 118 formed by each plasma generator 144 is flowed or otherwise transported along the plasma transport channel 158 from the plasma formation region 154 to the corresponding plasma injector 146 for injection into the acceleration region 128. It is appreciated that the portions of the precursor plasma 118 formed by the two plasma generators 144 may have the same or different plasma compositions or parameters. Transport of the precursor plasma 118 along the plasma transport channel 158 can be achieved by or as a result of the axial momentum imparted to the precursor plasma 118 as it leaves the plasma formation region 154. In particular, the formation of the precursor plasma 118 can result in a radial electric current and an azimuthal magnetic field. The interaction between the radial electric current and the azimuthal magnetic field produces an axial Lorentz force that pushes and accelerates the precursor plasma 118 forward along the plasma formation region and into the plasma transport channel 158 toward the plasma injector 146.

Each plasma injector 146 is provided as a plasma injection port or opening formed through the outer peripheral surface of the outer electrode 126 of the plasma confinement device 110 and establishing a pathway between the plasma transport channel 148 of the corresponding plasma generator 144 and the acceleration region 128 of the plasma confinement device 110. The plasma injectors 146 can be used to control the rate of introduction of the precursor plasma 118 into the acceleration region 128 and the plasma properties, which in turn can provide better control over the lifetime and other properties of the Z-pinch plasma 120. It is appreciated that the parameters of each plasma injector 146 may be individually adjusted in accordance with the application. For example, in the embodiment of FIGS. 2 and 3, the two plasma injectors 146 have diametrically opposed azimuthal positions but have otherwise identical parameters. In other embodiments, the plasma injectors 146 may differ from one another in other respects. Non-limiting examples of plasma injector parameters include the size, shape, and configuration of the injection port; the axial and/or azimuthal position of the injection port with respect to the Z-pinch axis 122; the plasma injection plane, which is defined as the plane encompassing the Z-pinch axis 122 and the plasma formation axis 148 of the plasma generator 144; and the plasma injection angle, which is defined as the angle between the Z-pinch axis 122 and the plasma formation axis 148. For example, in the embodiment of FIGS. 2 and 3, the flow direction of the precursor plasma 118 along the plasma transport channel 148 makes an acute angle with the flow direction of the precursor plasma 118 along the acceleration region 128.

Furthermore, the injection of the precursor plasma 118 may be controlled by adjusting the relative orientation between the velocity of the precursor plasma 118 injected into the acceleration region 128 and the magnetic field present in the acceleration region 128. For example, the velocity of the precursor plasma 118 may be strictly axial, strictly radial, or it may have both a radial and an axial component. It is appreciated that the embodiment of FIGS. 2 and 3 is provided by way of example only, and that various other plasma injection configurations are contemplated for used in the present techniques. For example, in some embodiments, it could be envisioned to inject the precursor plasma 118 into the acceleration region 128 via one or more injection ports formed in the inner electrode 124.

In some embodiments, the radionuclide production system 100 may include a vacuum system 170. The vacuum system 170 includes a vacuum chamber 172, for example, a stainless steel pressure vessel. The vacuum chamber 172 is configured to house at least partially various components of the radionuclide production system 100, including at least part of the inner electrode 124 and the outer electrode 126 of the plasma confinement device 110. The vacuum chamber 172 may include vacuum ports 174 formed therethrough to allow the precursor plasma 118 formed by the plasma formation and injection device 112 and to be coupled into the reaction chamber 116 of the plasma confinement device 110. The vacuum system 170 may also include a pressure control system 176 configured to control the operating pressure inside the vacuum chamber 172. In some embodiments, the pressure inside the vacuum chamber 172 may range from about 10⁻⁹ Torr to about 20 Torr, although other ranges of pressure may be used in other embodiments.

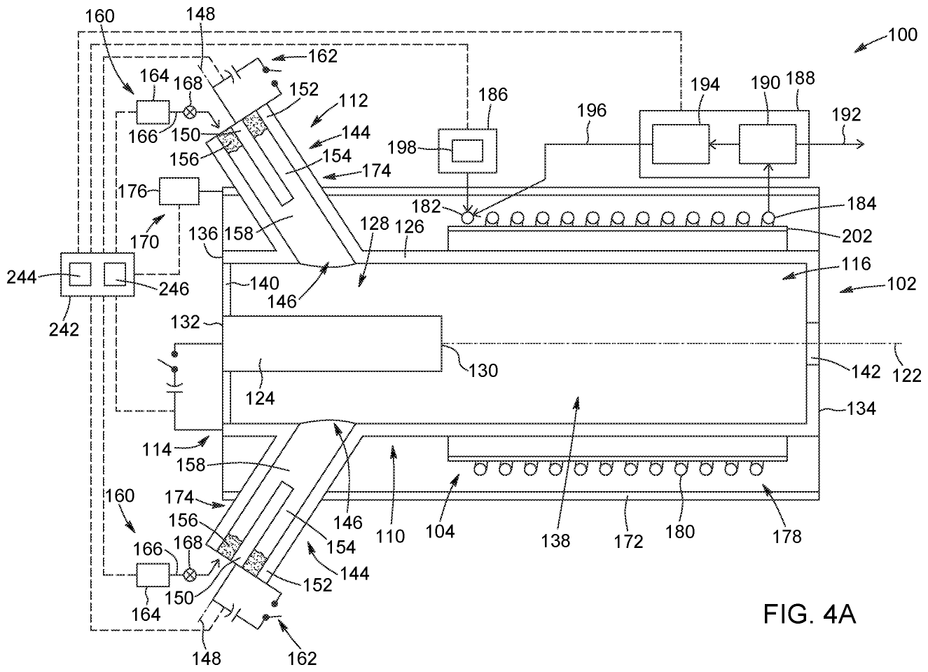

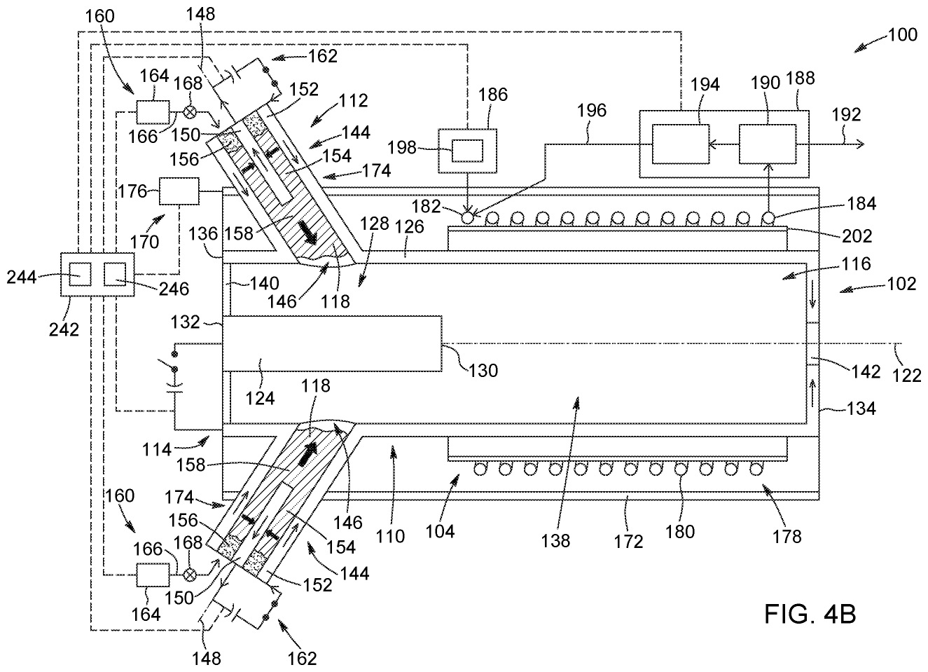

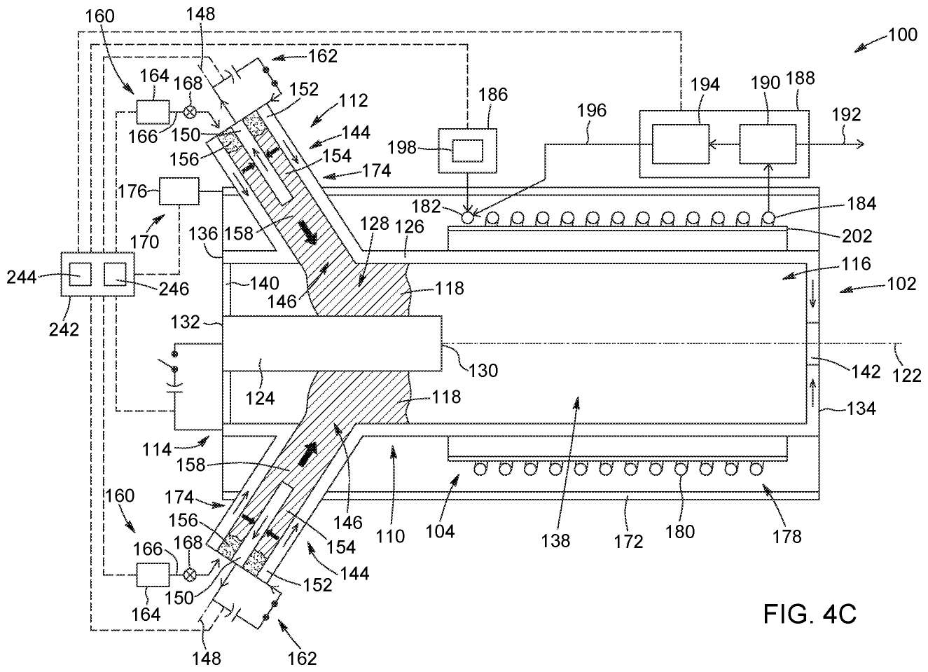

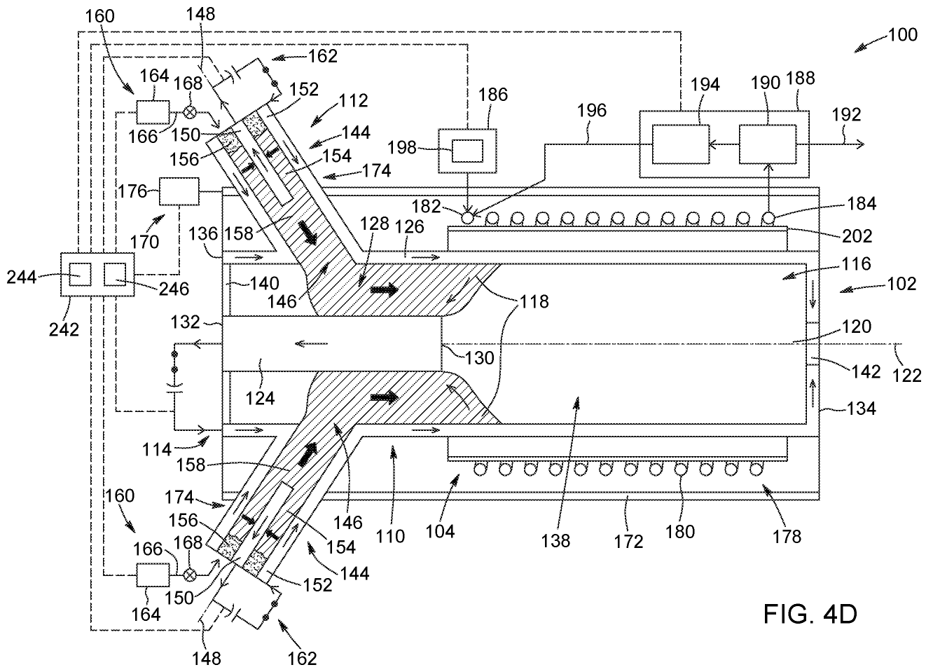

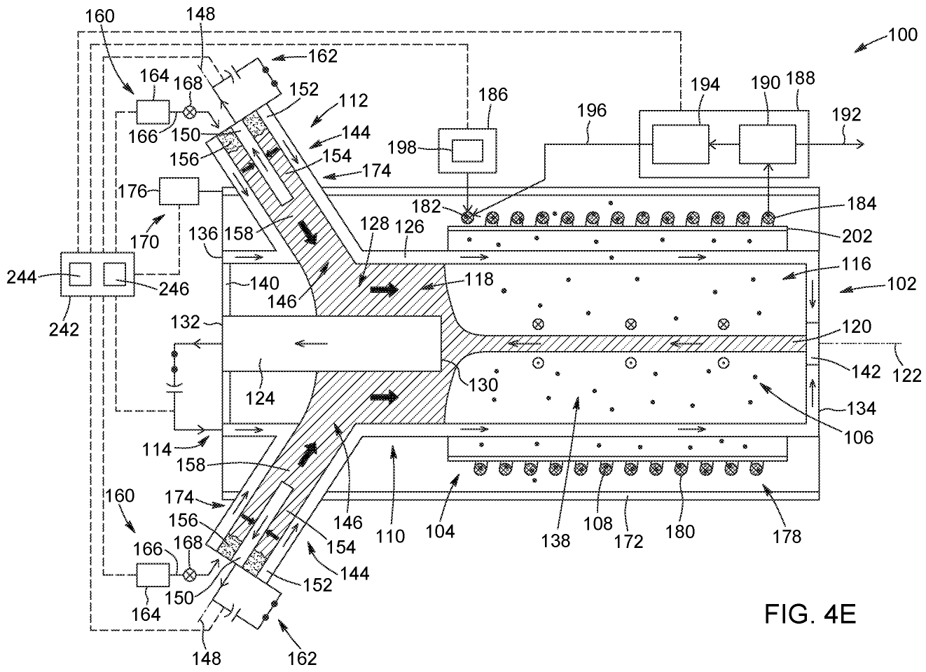

Referring to FIGS. 4A to 4E, the process of generating a neutron flux 106 using a Z-pinch-based neutron source 102 of an embodiment of a radionuclide production system 100 will be described in greater detail. It is noted that the process of generating a neutron flux 106 can correspond to step 302 of the embodiment of the radionuclide production method 300 depicted in the flow diagram illustrated in FIG. 1. The radionuclide production system 100 depicted in FIGS. 4A to 4E corresponds to that illustrated in the embodiment of FIGS. 2 and 3, depicted at five different stages of its operation.

Referring to FIG. 4A, the neutron flux generation process can include a step of forming a precursor plasma 118 outside the reaction chamber 116 of the plasma confinement device 110. The formation of the precursor plasma 118 can include a step of using a process gas supply unit 160 to introduce process gas 156 into the plasma formation region 154 of each plasma generator 144 of the plasma formation and injection device 112. Referring to FIG. 4B, the formation of the precursor plasma 118 can also include a step using a plasma formation power supply 162 to apply a voltage between the inner electrode 150 and the outer electrode 152 of each plasma generator 144 to energize the process gas 156 into the precursor plasma 118. Once formed, the precursor plasma 118 is accelerated along the plasma formation region 154 and the plasma transport channel 158 toward each plasma injector 146. In FIGS. 4A and 4B, the operation of introducing the process gas 156 into the plasma formation region 154 is initiated before initiating the operation of activating the plasma formation power supply 162 to apply the voltage between the inner electrode 150 and the outer electrode 152 of each plasma generator 144. In some embodiments, the time delay between initiating the introduction of the process gas 156 into the plasma formation region 154 and initiating the activation of the plasma formation power supply 162 can range between about 500 μs and 3 ms. In other embodiments, the operation of introducing the process gas 156 into the plasma formation region 154 can be initiated at the same time as or after initiating the operation of activating the plasma formation power supply 162. Referring to FIG. 4C, the neutron flux generation process can include a step of introducing the precursor plasma 118 inside the reaction chamber 116 of the plasma confinement device 110. In FIG. 4C, the introduction of the precursor plasma 118 inside the reaction chamber 116 includes a step of injecting the precursor plasma 118 into the acceleration region 128 of the reaction chamber 116.

Referring to FIGS. 4D and 4E, the neutron flux generation process can include a step of using the main power supply 114 to supply power to the plasma confinement device 110 for applying a voltage between the inner electrode 124 and the outer electrode 126. It is appreciated that the injection of the precursor plasma 118 into the acceleration region 128 of the plasma confinement device 110 can be a complex and delicate process, which involves the coupling of the precursor plasma 118 with the magnetic field present in the acceleration region 128 and created by the application of the voltage between the inner electrode 124 and the outer electrode 126 of the plasma confinement device 110. In the illustrated embodiment, the operation of activating the main power supply 114 is initiated after initiating the operation of introducing the precursor plasma 118 into the acceleration region 128. In some embodiments, the time delay between initiating the introduction of the precursor plasma 118 into the acceleration region 128 and initiating the activation of the main power supply 114 can range from about 0 μs to about 200 μs. In other embodiments, the operation of activating the main power supply 114 can be initiated before or at the same time as initiating the operation of introducing the precursor plasma 118 into the acceleration region 128.

The voltage applied by the main power supply 114 is configured to cause the precursor plasma 118 to flow along the acceleration region 128 and into the assembly region 138 (FIG. 4D) and to be compressed into the Z-pinch plasma 120 in the assembly region 138 (FIG. 4E). In the acceleration region 128, the precursor plasma 118 allows electric current to flow radially therethrough between the inner electrode 124 and the outer electrode 126. The electric current that flows axially along the inner electrode 124 generates an azimuthal magnetic field in the acceleration region 128. The interaction between the radial electric current flowing in the precursor plasma 118 and the azimuthal magnetic field produces an axially directed Lorentz force that propels the precursor plasma 118 forward along the acceleration region 128 until the precursor plasma 118 reaches the assembly region 138 and the Z-pinch plasma 120 begins to form. In the assembly region 138, the direction of the Lorentz force changes from axially forward to radially inward, which makes the plasma column collapse inwardly toward the Z-pinch axis 122 to complete the formation of the Z-pinch plasma 120. The axial current flowing in the Z-pinch plasma 120 generates an azimuthal magnetic field that exerts an inward magnetic pressure and an inward magnetic tension that radially compress the Z-pinch plasma 120 against the outward plasma pressure until an equilibrium is established. For radionuclide production, the Z-pinch plasma 120 is compressed until fusion conditions are reached and a neutron flux 106 is generated and directed outwardly away from the Z-pinch plasma 120. The steps of introducing the precursor plasma 118 inside the acceleration region 128 and supplying power to the plasma confinement device 110 can be maintained over a certain duration to sustain the Z-pinch plasma 120 and the neutron flux 106 irradiating therefrom.

In some embodiments, the Z-pinch plasma 120 may have the following properties and parameters: a plasma radius ranging from about 0.1 mm to about 5 mm, a magnetic field ranging from about 1 T to about 8 T, an electron temperature ranging from about 500 eV to about 10 keV, an ion temperature ranging from about 500 eV to about 10 keV, an electron density ranging from about 10¹⁶ cm⁻³ to about 10²⁰ cm⁻³, an ion density ranging from about 10¹⁶ cm⁻³ to about 10²⁰ cm⁻³, and a stable lifetime exceeding 10 s (e.g., up to 1 ms). These values are provided by way of example, so that other values may be used in other embodiments. In some embodiments, the Z-pinch-based neutron source 102 is configured to generate the neutron flux 106 with an average neutron energy ranging from about 2 MeV (e.g., D-D reaction) to about 15 MeV (e.g., D-T reaction). The parameters of the neutrons generated by the Z-pinch plasma 120 and forming the neutron flux 106 can be varied and adjusted to suit the needs of a particular application. Non-limiting examples of such parameters include, to name a few, the energy spectrum, yield, and emission duration of the neutrons forming the neutron flux 106. Depending on the application, the Z-pinch plasma 120 may or may not be sheared-flow-stabilized, and the neutron emission may or may not be pulsed.

Returning to FIGS. 2 and 3, the target holder 104 is configured to hold the target 108 and expose the target 108 to the neutron flux 106 generated by the Z-pinch plasma 120. The target 108 contains neutron-activatable nuclides which, upon exposure of the target 108 to the neutron flux 106, are converted to radionuclides through neutron activation. Depending on the application, the target holder 104 can have various arrangements and configurations. In the illustrated embodiment, the target holder 104 extends circumferentially around the assembly region 138 of the plasma confinement device 110 of the Z-pinch-based neutron source 102. The target holder 104 is located outside the outer electrode 126 but inside the vacuum chamber 172. It is appreciated that forming and sustaining the Z-pinch plasma 120 under conditions where fusion neutrons are generated can be a complex and delicate process, which generally takes place in a confined space under tightly controlled operating conditions. The provision of the target holder 104 outside the Z-pinch-based neutron source 102—at a sufficient distance from the region where the Z-pinch plasma 120 is formed and sustained and neutron generation occurs—can improve the stability of the radionuclide production process. This is because the radionuclide production process does not interfere, or interfere negligibly, with the neutron generation process.

The target 108 may be provided as a solid target material or a fluid target material containing the neutron-activatable nuclides. The provision of the target 108 as a fluid material can be advantageous or required in embodiments where the target 108 is circulated or flowed with respect to the Z-pinch plasma 120 during neutron irradiation and radionuclide production. In some embodiments, the target 108 may be provided as a slurry or another form of flowable material or mixture containing the neutron-activatable nuclides. In the case of ⁹⁸Mo(n,γ)⁹⁹Mo production, the slurry or mixture may be produced from natural molybdenum (24.29% abundance of ⁹⁸Mo) in the form of MoO₃ dissolved in a solution, for example, by diluting MoO₃ powder in NaOH. It is appreciated that the term “fluid” as used herein is meant to encompass substances of various viscosities. Depending on the application, a fluid target material can refer to a pure substance; a homogeneous solution containing one or more solutes dissolved in a solvent; a heterogeneous suspension, dispersion, emulsion, or multi-phase mixture; a slurry; a cream; a gel; a paste; and the like.

Depending on the application, the target holder 104 is configured to move the target 108 or maintain it stationary with respect to Z-pinch-based neutron source 102 during exposure of the target 108 to the neutron flux 106 and radionuclide production. For example, in the embodiment of FIGS. 2 and 3, the target holder 104 is be configured to circulate the target 108 along a circulation path 178 extending around and spaced radially outwardly from the Z-pinch axis 122. Depending on the application, the circulation path 178 can include less than one, one, or multiple turns around the Z-pinch axis 122. In some embodiments, the circulation path 178 can extend in a helical or spiral manner around the Z-pinch axis 122. For example, in the illustrated embodiment, the circulation path 178 extends helically around the Z-pinch axis 122, radially outwardly of the outer electrode 126 and over an axial portion of the assembly region 138.

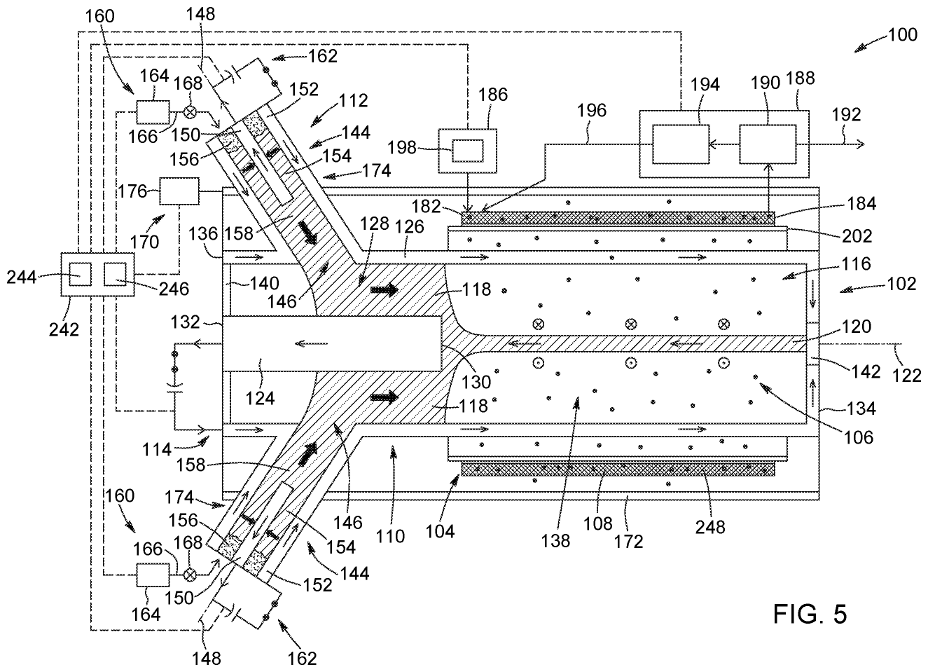

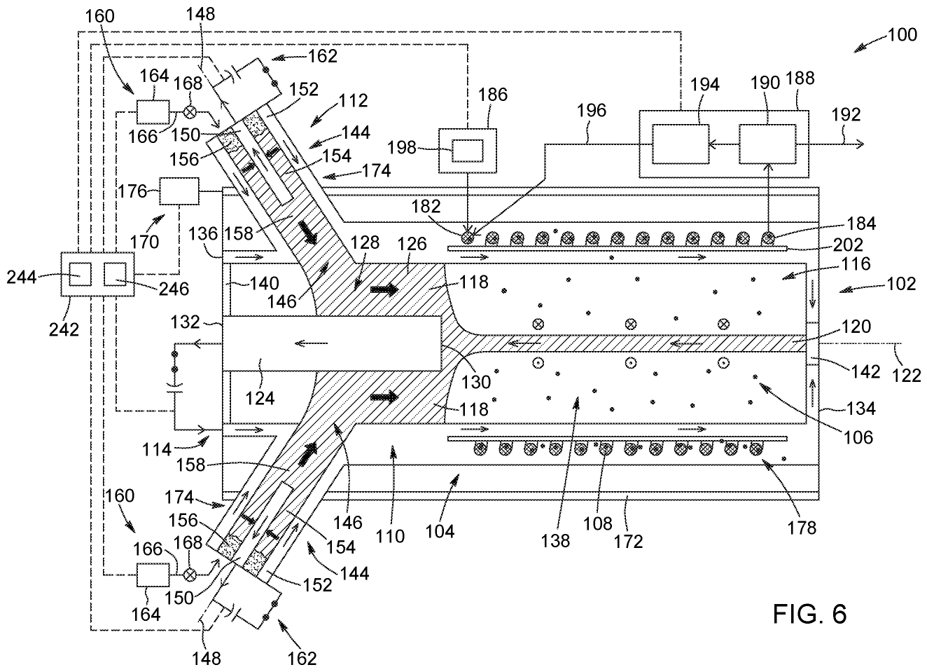

In some embodiments, the target holder 104 includes at least one conduit 180 exposed to the neutron flux 106 and configured to circulate a flow of the target 108 therealong. It is appreciated that circulating the target 108 as a fluid material in one or more conduits 180 wrapped around the Z-pinch plasma 120 can increase the effective area of the target 108 exposed to the neutron flux 106. Such a configuration can be advantageous in that it may be used with lower neutron fluxes than radionuclide production techniques involving neutron irradiation of a spatially localized solid target. The conduit 180 may be embodied by a pipe, a tube, or any suitable enclosed channel capable of flowing the target 108 therealong. However, in other embodiments, the target holder 104 may have another configuration, such as a tank or a bladder, whether in stationary or moving target implementations. For example, referring to FIG. 5, there is illustrated another embodiment of a radionuclide production system 100 in which the target holder 104 is configured as a tank 248 shaped as cylindrical shell coaxial with the Z-pinch axis 122 and radially interposed between outer electrode 126 of the plasma confinement device 110 and the vacuum chamber 172. The tank 248 is configured to contain the target 108 during neutron irradiation and radionuclide production. It is noted that the embodiment of FIG. 5 may otherwise share several features with the embodiment of FIGS. 2 and 3, which need not be described again. In the embodiment of FIGS. 2 and 3, the conduit 180 is disposed outside the outer electrode 126 and is helically wrapped around the assembly region 138, where the Z-pinch plasma 120 is produced and the neutron flux 106 is generated. However, in other embodiments, the conduit 180 may be provided at various other locations intercepted by the neutron flux 106, notably at any location that does not disturb the Z-pinch plasma 120. For example, in some embodiments, the conduit 180 may be located inside the outer electrode 126, as depicted in FIG. 6. It is noted that the embodiment of FIG. 6 may otherwise share several features with the embodiment of FIGS. 2 and 3, which need not be described again. In other embodiments, it may be contemplated to provide the conduit 180 inside the inner electrode 124, inside the acceleration region 128, inside the assembly region 138, or outside the vacuum chamber 172.

Returning to FIGS. 2 and 3, the conduit 180 includes a conduit inlet 182 configured to receive the flow of the target 108 prior to exposure of the target 108 to the neutron flux 106 and radionuclide production, and a conduit outlet 184 configured to discharge the flow of the target after exposure of the target to the neutron flux 106 and radionuclide production. In some embodiments, the conduit 180 may have a circular cross-section, a radius ranging from about 5 mm to about 100 mm, and a wall thickness ranging from about 1 mm to 10 mm, although the size, shape, structure, and arrangement of the conduit 180 can be varied in other embodiments. The conduit 180 may be made of stainless steel, for example, 304 stainless steel or 316 stainless steel, or another suitable material. In this regard, it is appreciated that the components of the system 100 interposed between the Z-pinch plasma 120 and the target 108 should be substantially transparent to the neutron flux 106 in order for the neutron flux 106 to reach and irradiate the target 108 and produce radionuclides through neutron activation of the neutron-activatable nuclides contained in the target 108. In the illustrated embodiment, such components include the outer electrode 126 of the plasma confinement device 110 and the conduit 180 in which the target 108 flows.

Referring still to FIGS. 2 and 3, the conduit inlet 182 may be connected to a target source unit 186 configured to store and supply the target 108 to the target holder 104. In some embodiments, the target 108 may be supplied by the target source unit 186 as a flowable fluid material containing the neutron-activatable nuclides. For example, in the case of ⁹⁸Mo(n,γ)⁹⁹Mo production, the target 108 may be a slurry or mixture of MoO₃ powder diluted NaOH. The conduit outlet 184 may be connected to a target processing unit 188 configured to process the target 108 after exposure to the neutral flux 106. In the illustrated embodiment, the target processing unit 188 includes a radionuclide extractor 190 configured receive the exposed target 108 from the target holder 104 and extract the produced radionuclides 192 from the exposed target 108. The extraction of the produced radionuclides 192 from the exposed target 108 can be performed using various chemical and physical separation and extraction processes. For example, in the case of ⁹⁸Mo(n,γ)⁹⁹Mo production, the produced ⁹⁹Mo can be extracted from the irradiated target 108, which can include non-activated ⁹⁸Mo, by various processes, such as solvent extraction processes. The target processing unit 188 may also include a target recycling unit 194 configured to recycle non-activated neutron-activatable nuclides from the exposed target 108 for producing further radionuclides. The recycled target 196 may be fed back to the target holder 104 via the conduit inlet 182, with or without passing through the target source unit 186. In some embodiments, the system 100 can include a flow moving device 198, such as a pump provided in the target source unit 186, configured to control the flow of the target 108 from the conduit inlet 182 to the conduit outlet 184 of the conduit 180. The produced radionuclides 192 can be further processed for use in different applications. For example, in embodiments where the produced radionuclides 192 is ⁹⁹Mo, the produced ⁹⁹Mo can be delivered to the ⁹⁹Mo/^{99m}Tc supply chain to produce ^{99m}Tc radiopharmaceuticals and supply it to healthcare facilities for use in nuclear medicine procedures.

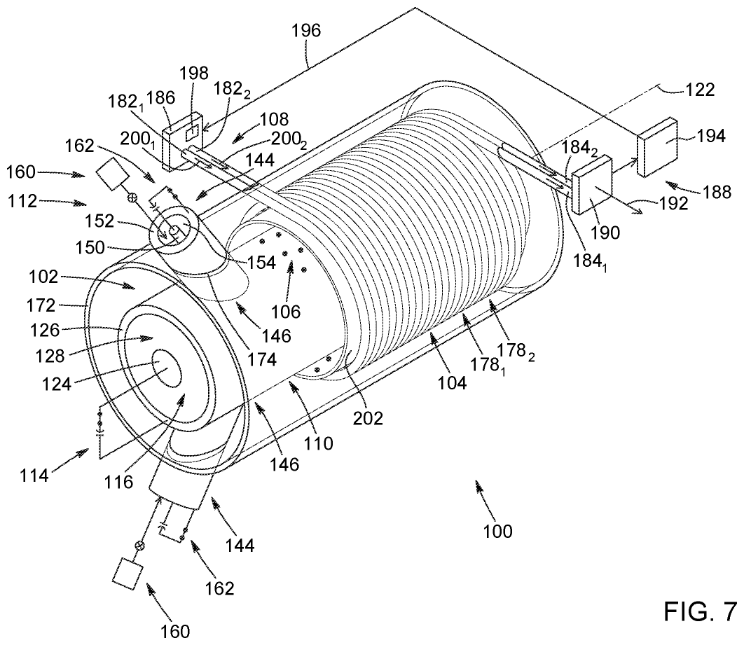

In the embodiment of FIGS. 2 and 3, the target holder 104 includes a single conduit 180. However, in other embodiments, the target holder 104 may include a plurality of conduits 180, each having its own conduit inlet 182 and conduit outlet 184, and each being configured to circulate therein a respective portion or flow of the target 108. Reference is made in this regard to FIGS. 7 to 9. Depending on the application, the different flows of the target 108 circulating in the different conduits 180 may or may not contain the same type of neutron-activatable nuclides. It is appreciated that by circulating target flows containing different types of neutron-activatable nuclides in different conduits 180, and by exposing the different neutron-activatable nuclides to the neutron flux 106 generated by the Z-pinch-based neutron source 102, the present techniques can allow for the concurrent production of different types of radionuclides, or the concurrent production of the same type of radionuclides using different reaction routes, for example, ⁹⁸Mo(n,γ)⁹⁹Mo production in a first conduit or set of conduits and ¹⁰⁰Mo(n,2n)⁹⁹Mo production in a second conduit or set of conduits.

In FIG. 7, the target holder 104 includes a first conduit 180₁ and a second conduit 180₂ wrapped about the Z-pinch axis 122 in interleaved helical circulation paths 178₁, 178₂ extending outside and over an axial portion the assembly region 138. The first and second conduits 180₁, 180₂ can each have its own conduit inlet 182₁, 182₂ and conduit outlet 184₁, 184₂. The first conduit 180₁ is configured to circulate a first flow 200₁ of the target 108 including a first type of neutron-activatable nuclides. The second conduit 180₂ is configured to circulate a second flow 200₂ of the target 108 including a second type of neutron-activatable nuclides. Depending on the application, the second type of neutron-activatable nuclides is the same as or different from the first type of neutron-activatable nuclides. For example, in some implementations, the neutron-activatable nuclides of the first type can include ⁹⁸Mo, from which ⁹⁹Mo is produced as a first type of radionuclides through the reaction ⁹⁸Mo(n,γ)⁹⁹Mo, and the neutron-activatable nuclides of the second type can include ¹⁰⁰Mo, from which ⁹⁹Mo is produced as a second type of radionuclides through the reaction ¹⁰⁰Mo(n,2n)⁹⁹Mo.

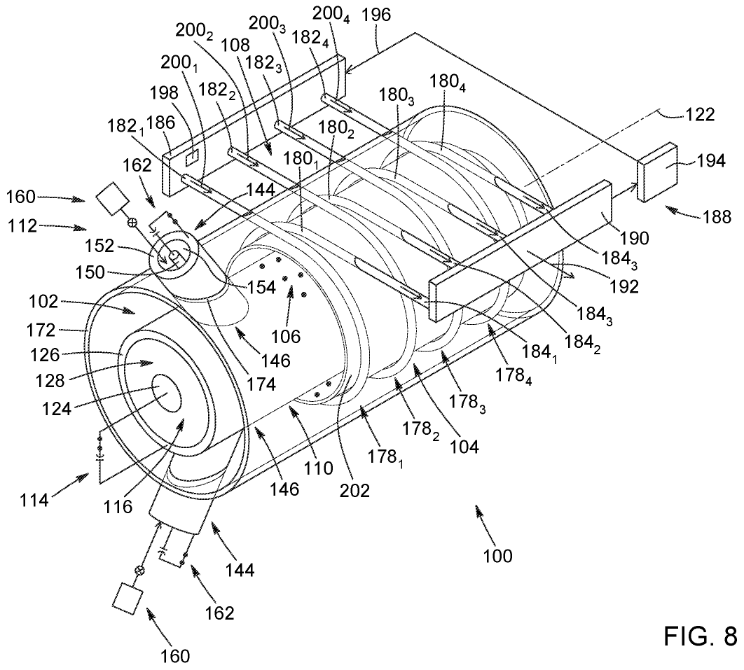

Referring to FIG. 8, the target holder 104 includes four conduits 180₁-180₄, each of which having its own conduit inlet 182₁-182₄ and conduit outlet 184₁-184₄ and configured to flow a respective flow 200₁-200₄ of the target 108 therein, where the four conduits 180₁, 180₂ are helically wrapped about the Z-pinch axis 122 along four axially spaced circulation paths 178₁-178₄ extending disposed outside and over an axial portion the assembly region 138. It is appreciated that providing multiple shorter conduits 180₁-180₄, each with fewer loops around the Z-pinch plasma 120, as in FIG. 8, rather than a single longer conduit 180, as in FIGS. 2 and 3, can be advantageous in some applications. This is because such a configuration may allow for better control over the target flow and a better understanding of the target-neutron interaction. Depending on the application, the types of neutron-activatable nuclides circulating in any pair of the four conduits 180₁-180₄ may or may not be the same.

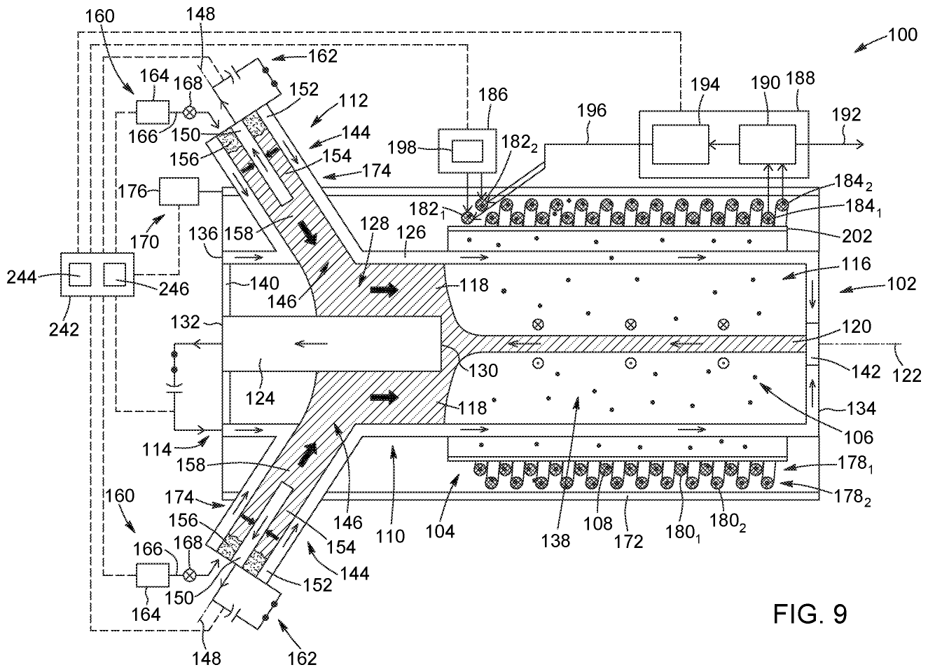

In FIG. 9, the target holder 104 includes two conduits 180₁, 180₂ helically wrapped about the Z-pinch axis 122 in a radially stacked arrangement extending outside and over an axial portion the assembly region 138. Depending on the application, the types of neutron-activatable nuclides circulating in the two conduits 180₁, 180₂ may or may not be the same.

It is appreciated that the radionuclide production system 100 in each of the embodiments of FIGS. 7 to 9 shares several features with the plasma processing system 100 of the embodiment of FIGS. 2 and 3, which will not be described again other than to highlight differences between them.

Returning to FIGS. 2 and 3, in some embodiments, the system may include a neutron moderator 202 arranged in a path of the neutron flux 106 between the Z-pinch plasma 120 and the target 108. The neutron moderator 202 is configured to thermalize, that is, to slow down or reduce the average energy of the neutron flux 106 prior to the neutron flux 106 reaching the target 108. In some embodiments, the moderated neutron flux may have an average energy ranging from less than one eV (e.g., as low as 0.0025 eV to include thermal and epithermal neutrons) to a few hundreds of eV. In some embodiments, the neutron moderator 202 may include one or more layers or sheets disposed around the Z-pinch axis 122, radially outwardly of the reaction chamber 116 of the Z-pinch-based neutron source 102 and radially inwardly of the target holder 104. The neutron moderator 202 may be made of various moderator materials, non-limiting examples of which include, to name a few, water, heavy water, graphite, beryllium, polyethylene, hydrocarbons, and paraffin wax. It is appreciated that the location, composition, structure, and arrangement of the neutron moderator 202 can be varied depending on the application, and that various neutron moderation configurations and techniques are contemplated. It is also appreciated that the theory and principles of operation of neutron moderators are generally known in the art and need not be described in detail herein other than to facilitate an understanding of the present techniques.

It is appreciated that the Z-pinch-based neutron source 102 depicted in FIGS. 2 and 3 is provided by way of example only, and that various other types of Z-pinch plasma generation systems are contemplated for use as neutron sources in other embodiments. In the Z-pinch-based neutron source 102 of FIGS. 2 and 3, the precursor plasma 118 is formed outside the acceleration region 128 of the plasma confinement device 110, and the externally formed precursor plasma 118 is injected into the acceleration region 128, and subsequently accelerated and compressed into a neutron-generating Z-pinch plasma 120. In such embodiments, fusion conditions and neutron generation may be established in the Z-pinch plasma 120 as a result of two decoupled and separately controlled processes: a plasma formation process and a plasma acceleration and compression process. However, in other embodiments, a precursor plasma may be formed inside the acceleration region, typically by injection and ionization of a neutral gas, and the internally formed plasma may be accelerated along the acceleration region and into the assembly region to be compressed into a Z-pinch plasma. Non-limiting examples of neutral-gas-based Z-pinch plasma generation systems are disclosed in patent application PCT/US2018/019364 (published as WO 2018/156860) and Golingo, Raymond, Formation of a Sheared Flow Z-Pinch (Doctoral thesis, University of Washington, 2003), which have been mentioned above and whose contents are incorporated herein by reference in their entirety.

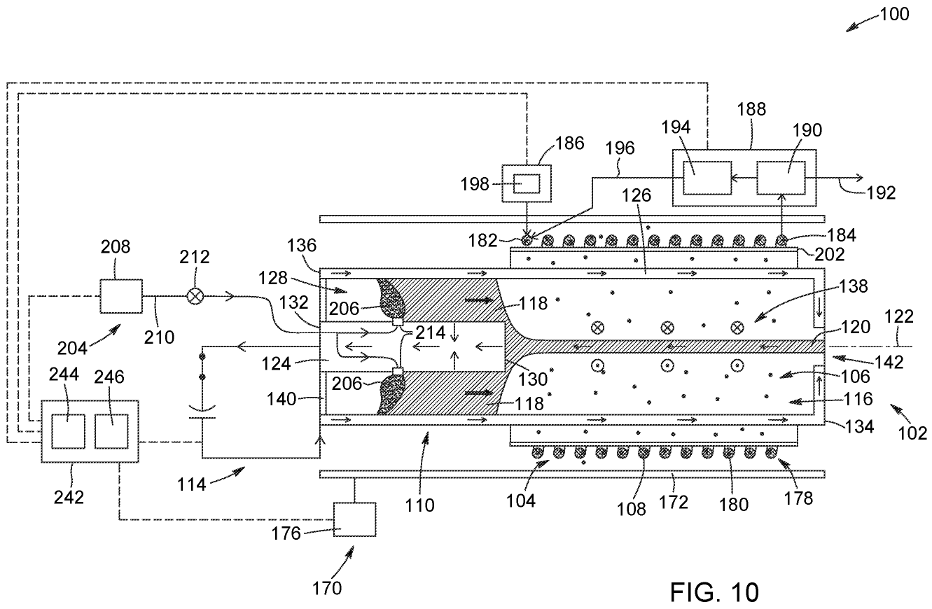

FIG. 10 illustrates an example of an embodiment of a radionuclide production system 100 implementing a neutral-gas-based approach to forming a Z-pinch plasma 120. The embodiment of FIG. 10 shares several features with the embodiment of FIGS. 2 and 3, which will not be described again other than to highlight differences between them. The system 100 of FIG. 10 generally includes a Z-pinch-based neutron source 102 configured to generate a neutron flux 106, and a target holder 104 configured to hold a target 108 including neutron-activatable nuclides and expose the target 108 to the neutron flux 106 to produce radionuclides through neutron activation of the neutron-activatable nuclides. The Z-pinch-based neutron source 102 includes a plasma confinement device 110 including a reaction chamber 116, an inner electrode 124, and an outer electrode 126 surrounding the inner electrode 124 to define therebetween an acceleration region 128 of the reaction chamber 116. The outer electrode 126 extends axially beyond the inner electrode 124 along a Z-pinch axis 122 to define an assembly region 138 of the reaction chamber 116 adjacent the acceleration region 128. The Z-pinch-based neutron source 102 also includes a precursor gas supply device 204 configured to supply a precursor gas 206 inside the acceleration region 138, and a main power supply 114 configured to supply power to the plasma confinement device 110 to apply a voltage between the inner electrode 124 and the outer electrode 126. The application of the voltage is configured to ionize or otherwise energize the precursor gas 206 into a precursor plasma 118 and to cause the precursor plasma 118 to flow along the acceleration region 128 and into the assembly region 138 and to be compressed into the Z-pinch plasma 120 along the Z-pinch axis 122 in the assembly region 138.

Like the process gas 156 used in the embodiment of FIGS. 2 and 3, the precursor gas 206 in the embodiment of FIG. 10 can be any suitable gas or gas mixture containing fusion reactants that can undergo neutronic fusion reactions when compressed into the Z-pinch plasma 120. Depending on the application, the precursor gas 206 can be a neutral gas or gas mixture, or a weakly ionized gas or gas mixture. In some embodiments, the precursor gas 206 may be deuterium gas (D-D reaction) or a gas mixture containing deuterium and tritium (D-T reaction). Other mixtures may include hydrogen or helium. The precursor gas supply device 204 can include or be coupled to a precursor gas source 208 configured to store the precursor gas 206. The precursor gas source 208 may be embodied by a gas storage tank or any suitable pressurized gas dispensing container. The precursor gas supply device 204 may also include a precursor gas supply line 210 (e.g., including gas conduits or channel) configured to convey the precursor gas 206 from the precursor gas source 208 to the acceleration region 128 of the plasma confinement device 110. The precursor gas supply device 204 may further include a precursor gas supply valve 212 or other flow control devices configured to control a flow of the precursor gas 206 along the precursor gas supply line 210, from the precursor gas source 208 to acceleration region 128. The precursor gas supply valve 168 may be embodied by a variety of electrically actuated valves, such as solenoid valves. Other flow control devices (not shown), such as pumps, regulators, and restrictors, may be provided to control the precursor gas flow rate and pressure along the precursor gas supply line 210. Various precursor gas injection configurations may be used depending on the application.

To allow injection of the precursor gas 206 into the acceleration region 128, the plasma confinement device 110 can include precursor gas injection ports 214 connected to the process gas supply line 210 and leading into the acceleration region 128. For example, in the illustrated embodiment, the plasma confinement device 110 includes two process gas injection ports 214 formed through the inner electrode 124 at opposite azimuthal positions with respect to the Z-pinch axis 122. Depending on the application, the precursor gas injection ports 214 may be formed only through the inner electrode 124, only through the outer electrode 126, through both the inner electrode 124 and the outer electrode 126, or at any other suitable locations of the plasma confinement device 110. The gas injection configuration and the number and arrangement of the precursor gas injection ports 214 can be varied to suit the needs of a particular application.

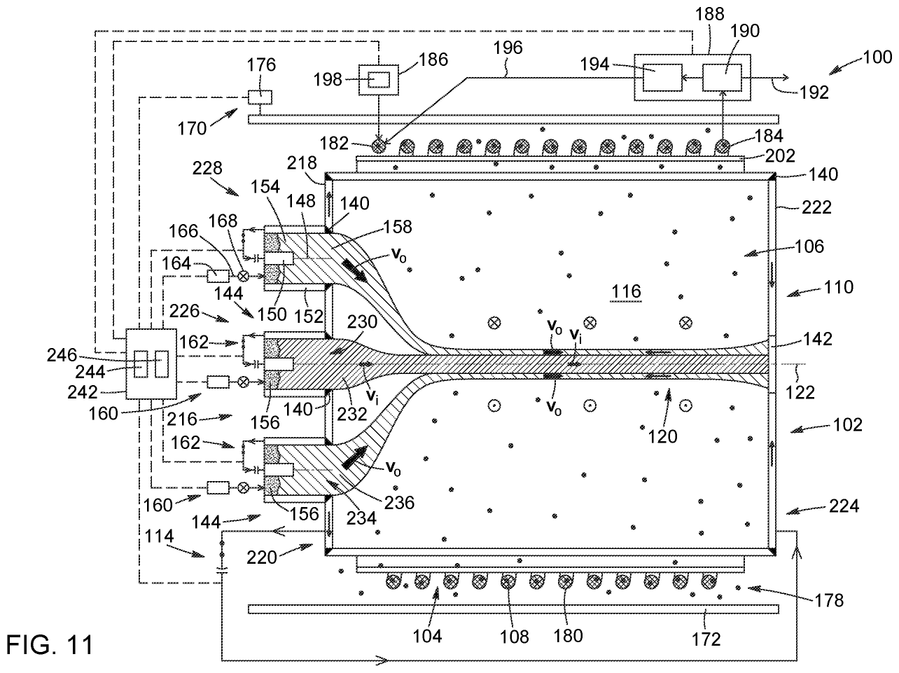

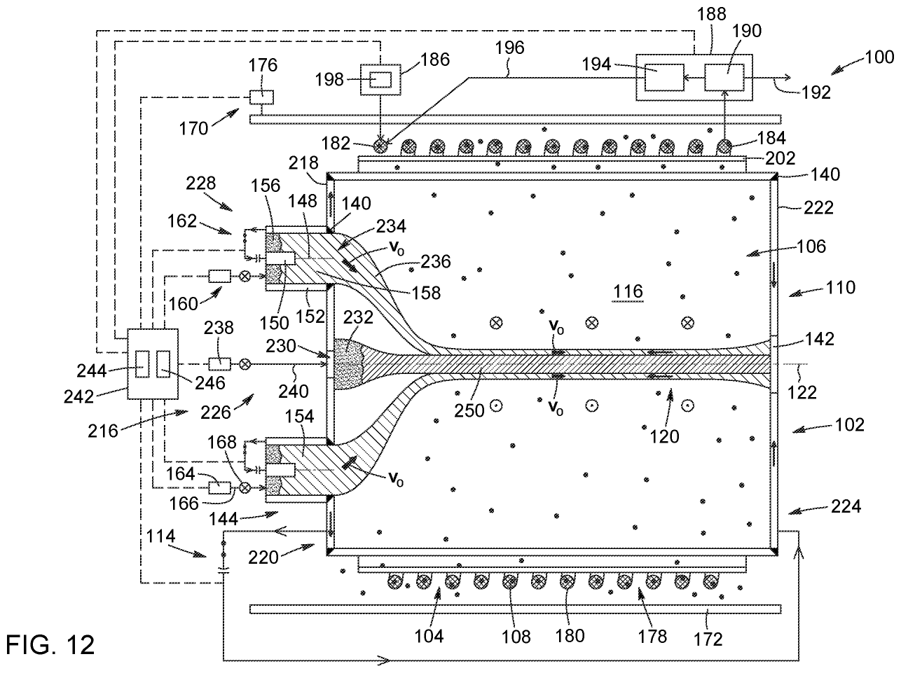

In other embodiments, the Z-pinch plasma generation system used as a neutron source need not include a plasma acceleration region followed by a pinch assembly region. For example, referring to FIGS. 11 and 12, there are illustrated other embodiments of a radionuclide production system 100. The embodiments of FIGS. 11 and 12 share several features with the embodiment of FIGS. 2 and 3, which will not be described again other than to highlight differences between them. The system 100 of FIGS. 11 and 12 generally includes a Z-pinch-based neutron source 102 configured to generate a neutron flux 106, and a target holder 104 configured to hold a target 108 including neutron-activatable nuclides and expose the target 108 to the neutron flux 106 to produce radionuclides through neutron activation of the neutron-activatable nuclides. The Z-pinch-based neutron source 102 generally includes a plasma confinement device 110, a precursor supply device 216, and a main power supply 114. The plasma confinement device 110 includes a reaction chamber 116, a first compression electrode 218 disposed at a first end 220 of the reaction chamber 116, and a second compression electrode 222 disposed at a second end 224 of the reaction chamber 116 spaced apart from the first end 220 along the Z-pinch axis 122. The precursor supply device 216 includes an inner precursor supply unit 226 and an outer precursor supply unit 228. The inner precursor supply unit 226 includes an inner injector 230 and is configured to supply, through the inner injector 230, an inner precursor medium 232 into the reaction chamber 116. Depending on the application, the inner precursor medium 232 can be an inner precursor plasma, as in FIG. 11, or an inner precursor gas, as in FIG. 12. In FIG. 11, the inner precursor supply unit 226 includes a single inner injector 230, although other embodiments can include multiple inner injectors 230. The outer precursor supply unit 228 includes four outer injectors 234 disposed radially outwardly of the inner injector 230 with respect to the Z-pinch axis 122 (only two outer injectors 234 are visible in the cross-sectional view of FIG. 11). In other embodiments, the number of outer injectors 234 can be smaller or larger than four. The outer precursor supply unit 226 is configured to supply, through the four outer injectors 234, an outer precursor plasma 236 into the reaction chamber 116 at an outer velocity vₙ. The main power supply 114 is configured to supply power to the plasma confinement device 110 to apply a voltage between the first compression electrode 218 and the second compression electrode 222. The applied voltage is configured to energize and compress the inner precursor medium 232 and the outer precursor plasma 236 into a Z-pinch plasma 120 having a radially sheared axial flow along the Z-pinch axis 122. The Z-pinch plasma 120 is compressed sufficiently to reach fusion conditions, whereby particles inside the Z-pinch plasma 120 undergo nuclear fusion reactions, including neutronic fusion reactions that produce a neutron flux 106 irradiating from the Z-pinch plasma 120.

In FIG. 11, the inner precursor medium 232 is an inner precursor plasma, and the inner precursor supply unit 226 is configured to supply the inner precursor plasma 232 into the reaction chamber 116 at an inner velocity v, different from the outer velocity vₒ of the outer precursor plasma 236 in order to control the sheared axial flow embedded inside the Z-pinch plasma 120 for stabilization. For example, in some embodiments, the magnitude of the velocity vₒ of the outer precursor plasma 236 can be controlled to be significantly larger than the magnitude of the velocity vᵢ of the inner precursor plasma, for example, by about 50 km/s to about 200 km/s, in order to provide sheared flow stabilization. In FIG. 11, the inner precursor supply unit 226 and the outer precursor supply unit 228 each include a plasma generator 144 configured to generate the inner precursor plasma 232 and the outer precursor plasma 236, respectively. The plasma generators 144 illustrated in FIG. 11 are configured as coaxial plasma guns and their structure and operation can be similar to those illustrated in the embodiment of FIGS. 2 and 3. The inner precursor supply unit 226 and the outer precursor supply unit 228 each include a process gas supply unit 160 configured to supply process gas 156 to each one of the plasma generators 144, and a plasma formation power supply 162 configured to supply power to each one of the plasma generators 144 to energize the process gas 156 into the inner precursor plasma 232 and the outer precursor plasma 236 for injection into the reaction chamber via the inner and outer injectors 230, 234.

In FIG. 12, the inner precursor medium 232 is an inner precursor gas, and the inner precursor supply unit 226 includes an inner precursor gas source 238 configured to store the inner precursor gas 232, and an inner precursor gas supply line 240 configured to transport the inner precursor gas 232 from the inner precursor gas source 238 to the inner injector 230 for injection of the inner precursor gas 232 into the reaction chamber 116. The inner precursor gas 232 includes fusion reactants that can undergo neutronic fusion reactions when compressed into the Z-pinch plasma 120. Its composition can be similar to those of the process gas 156 depicted in FIGS. 2 and 3 and the precursor gas 206 depicted in FIG. 10. The energization and compression process involves the ionization the inner precursor gas 232 into an inner plasma 250, and the energization and compression of the inner plasma 250 together with the outer precursor plasma 130 to form the Z-pinch plasma 132. It is noted that non-limiting examples of Z-pinch plasma generation devices configured to generate sheared-flow Z-pinch plasmas using techniques similar to those depicted in FIGS. 11 and 12 are disclosed in co-assigned International Patent Application No. PCT/US2022/012502, filed on Jan. 14, 2022, the contents of which are incorporated herein by reference in their entirety.

In FIGS. 11 and 12, the target holder 104 includes a conduit 180 disposed in a helical arrangement outside the reaction chamber 116 and inside the vacuum chamber 172. In other embodiments, the target holder 104 may have different structures and configurations and may be provided at other locations, for example, inside the reaction chamber 116 or outside the vacuum chamber 172. In FIGS. 11 and 12, the conduit 180 is wrapped around the outer circumference of the tubular lateral wall of the reaction chamber 116. The conduit 180 extends between a conduit inlet 182, which is connected to a target source unit 186, and a conduit outlet 184, which is connected to a target processing unit 188 including a radionuclide extractor 190 and a target recycling unit 194. A neutron moderator 202 is interposed radially between the reaction chamber 116 and the target holder 104. The structure and operation of the target holder 104 and the components coupled thereto depicted in FIGS. 11 and 12 can be similar to those described above with reference to FIGS. 2 and 3.

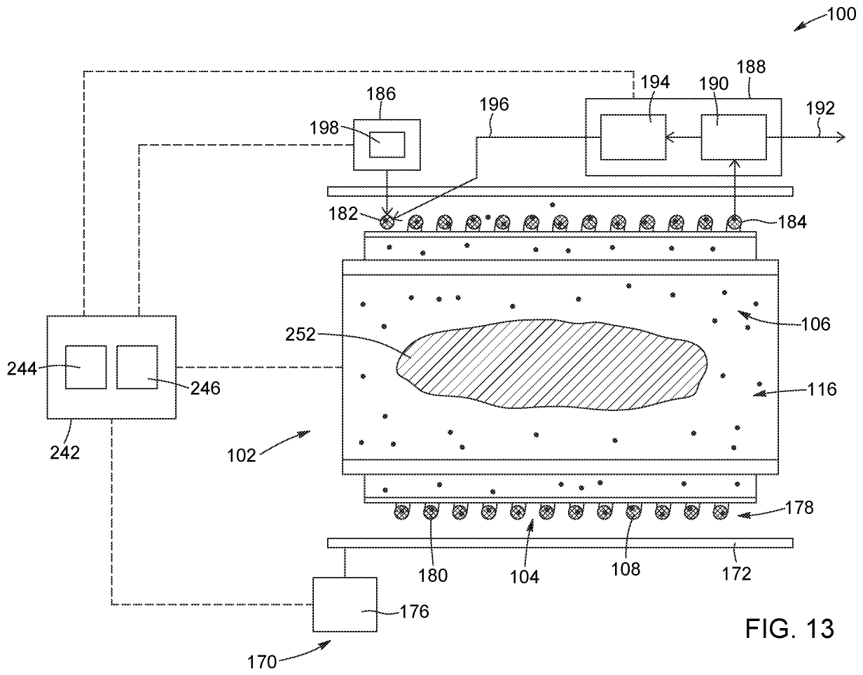

Several embodiments described above use Z-pinch plasma generation systems as compact plasma-based fusion neutron sources. However, other embodiments can use other types of plasma generation systems for producing fusion neutrons. Referring to FIG. 13, there is illustrated an embodiment of a system 100 for production of radionuclides which is based on a field-reversed-configuration (FRC) approach to forming the neutron-generating plasma. The system 100 generally includes an FRC neutron source 102 and a target holder 104. The FRC neutron source includes a reaction chamber 116 in which an FRC plasma 252 is formed and compressed at fusion conditions to produce a neutron flux 106. The term “field-reversed configuration” refers to a class of high-beta compact toroidal plasma confinement systems in which a toroidal electric current is induced inside a cylindrical plasma and generates a poloidal magnetic field that is reversed with respect to the direction an externally applied axial magnetic field. It is appreciated that the theory and operation of FRC-based plasma confinement systems in nuclear fusion applications are generally known in the art and need not be described in detail herein other than to facilitate an understanding of the present techniques. In particular, various FRC configurations can be used to implement the present techniques. The target holder 104 is configured to hold a target 108 including neutron-activatable nuclides. The target holder 104 is arranged with respect to the FRC neutron source 102 to expose the target 108 to the neutron flux 106 and produce radionuclides through neutron activation of the neutron-activatable nuclides. In FIG. 13, the target holder 104 includes a conduit 180 disposed in a helical arrangement outside the reaction chamber 116 of the FRC neutron source 102. In other embodiments, the target holder 104 may have different structures and configurations, as noted above with respect to other embodiments. The conduit 180 extends between a conduit inlet 182, which is connected to a target source unit 186, and a conduit outlet 184, which is connected to a target processing unit 188 including a radionuclide extractor 190 and a target recycling unit 194. A neutron moderator 202 is interposed radially between the reaction chamber 116 and the target holder 104. The structure and operation of the target holder 104 and the components coupled thereto depicted in FIG. 13 can be similar to those described above with reference to FIGS. 2 and 3.

Returning to FIGS. 2 and 3, it is appreciated that the embodiments of the radionuclide production system 100 disclosed herein may also include a control and processing device 242 configured for controlling, monitoring, and/or coordinating the functions and operations of various system components, including the Z-pinch-based neutron source 102 and the target holder 104, as well as various temperature, pressure, flow rate, and power conditions. Non-limiting examples of components that can be controlled by the control and processing device 242 include the main power supply 114; the process gas supply unit 160 and the plasma formation power supply 162 of the plasma formation and injection device 112; the target source unit 186; the flow moving device 198; the radionuclide extractor 190 and the target recycling unit 194 of the target processing unit 188; and the vacuum system 170. For example, the control and processing device 242 may be configured to control the operation of the each process gas supply unit 160 to supply the process gas 156 to the plasma formation region 154 of each plasma generators 144; to control the operation of each plasma formation power supply 162 to supply power to each plasma generator 144 to energize the process gas 156 into the precursor plasma 118; to control the operation of the main power supply 114 to apply a voltage between the inner and outer electrode 124, 126 of the plasma confinement device 110 to cause the precursor plasma 118 to flow along the acceleration region 128 and into the assembly region 138 to be compressed into the Z-pinch plasma 120; to control the operation of the flow moving device 198 to control the flow of the target 108 along the at least one conduit 180; to control the operation of the target source unit 186 to supply the target 108 to the conduit inlet 182 of the at least one conduit 180; to control the operation of the radionuclide extractor 190 to extract the produced radionuclides 192 from the exposed target 108; and to control the operation of the target recycling unit 194 recycle non-activated neutron-activatable nuclides from the exposed target 108 for use in further production of radionuclides. The control and processing device 242 may be configured to synchronize or otherwise time-coordinate the functions and operation of various components of the radionuclide production system 100. The control and processing device 242 may be implemented in hardware, software, firmware, or any combination thereof, and be connected to various components of the radionuclide production system 100 via wired and/or wireless communication links configured to send and/or receive various types of signals, such as timing and control signals, measurement signals, and data signals. The control and processing device 242 may be controlled by direct user input and/or by programmed instructions, and may include an operating system for controlling and managing various functions of the radionuclide production system 100. Depending on the application, the control and processing device 242 may be fully or partly integrated with, or physically separate from, the other hardware components of the radionuclide production system 100. The control and processing device 242 can include a processor 244 and a memory 246.

The processor 244 may be able to execute computer programs, also generally known as commands, instructions, functions, processes, software codes, executables, applications, and the like. It should be noted that although the processor 244 in FIGS. 2 and 3 is depicted as a single entity for illustrative purposes, the term “processor” should not be construed as being limited to a single processor, and accordingly, any known processor architecture may be used. In some implementations, the processor 244 may include a plurality of processing units. Such processing units may be physically located within the same device, or the processor 244 may represent processing functionality of a plurality of devices operating in coordination. For example, the processor 244 may include or be part of a computer; a microprocessor; a microcontroller; a coprocessor; a central processing unit (CPU); an image signal processor (ISP); a digital signal processor (DSP) running on a system on a chip (SoC); a single-board computer (SBC); a dedicated graphics processing unit (GPU); a special-purpose programmable logic device embodied in hardware device, such as, for example, a field-programmable gate array (FPGA) or an application-specific integrated circuit (ASIC); a digital processor; an analog processor; a digital circuit designed to process information; an analog circuit designed to process information; a state machine; and/or other mechanisms configured to electronically process information and to operate collectively as a processor.

The memory 246, which may also be referred to as a “computer readable storage medium” is capable of storing computer programs and other data to be retrieved by the processor 246. In the present description, the terms “computer readable storage medium” and “computer readable memory” are intended to refer to a non-transitory and tangible computer product that can store and communicate executable instructions for the implementation of various steps of the methods disclosed herein. The computer readable memory may be any computer data storage device or assembly of such devices, including a random-access memory (RAM); a dynamic RAM; a read-only memory (ROM); a magnetic storage device, such as a hard disk drive, a solid state drive, a floppy disk, and a magnetic tape; an optical storage device, such as a compact disc (CD or CDROM), a digital video disc (DVD), and a Blu-Ray™ disc; a flash drive memory; and/or any other non-transitory memory technologies. A plurality of such storage devices may be provided. The computer readable memory may be associated with, coupled to, or included in a computer or processor configured to execute instructions contained in a computer program stored in the computer readable memory and relating to various functions associated with the computer.

The radionuclide production system 100 may also include one or more user interface devices (not shown) operatively connected to the control and processing device 242 to allow the input of commands and queries to the radionuclide production system 100, as well as present the outcomes of the commands and queries. The user interface devices may include input devices (e.g., a touch screen, a keypad, a keyboard, a mouse, a switch, and the like) and output devices (e.g., a display screen, a printer, visual and audible indicators and alerts, and the like).

Numerous modifications could be made to the embodiments described above without departing from the scope of the appended claims.

1. A system for radionuclide production, the system comprising:
a compact plasma-based fusion neutron source configured to generate a neutron flux; and
a target holder configured to hold a target comprising neutron-activatable nuclides, the target holder being arranged with respect to the compact plasma-based fusion neutron source to expose the target to the neutron flux and produce radionuclides through neutron activation of the neutron-activatable nuclides.

2. The system of claim 1, wherein the produced radionuclides comprise ⁹⁹Mo.

3. The system of claim 2, wherein the neutron-activatable nuclides comprise ⁹⁸Mo, and wherein ⁹⁹Mo is produced from ⁹⁸Mo through the reaction ⁹⁸Mo(n,γ)⁹⁹Mo, where n stands for a neutron and γ stands for a gamma particle.

4. The system of claim 3, wherein the target comprises MoO₃ dissolved in a solution.

5. The system of any one of claims 2 to 4, wherein the neutron-activatable nuclides comprise ¹⁰⁰Mo, and wherein ⁹⁹Mo is produced from ¹⁰⁰Mo through the reaction ¹⁰⁰Mo(n,2n)⁹⁹Mo, wherein n stands for a neutron.

6. The system of any one of claims 1 to 5, wherein the target holder is configured to maintain the target stationary with respect to the compact plasma-based fusion neutron source during exposure of the target to the neutron flux.

7. The system of any one of claims 1 to 5, wherein the target holder is configured to move the target with respect to the compact plasma-based fusion neutron source during exposure of the target to the neutron flux.

8. The system of claim 7, wherein the target holder comprises at least one conduit exposed to the neutron flux and configured to circulate a flow of the target therealong, each conduit comprising a conduit inlet configured to receive the flow of the target prior to exposure of the target to the neutron flux, and a conduit outlet configured to discharge the flow of the target after exposure of the target to the neutron flux.

9. The system of claim 8, further comprising a flow moving device configured to control the flow of the target along the at least one conduit.

10. The system of claim 8 or 9, wherein the at least one conduit comprises a helical pattern.

11. The system of any one of claims 8 to 10, wherein the at least one conduit comprises a single conduit.

12. The system of any one of claims 8 to 10, wherein the at least one conduit comprises a plurality of conduits.

13. The system of claim 12, wherein the plurality of conduits comprises:
a first conduit configured to circulate a first flow of the target comprising a first type of neutron-activatable nuclides; and
a second conduit configured to circulate a second flow of the target comprising a second type of neutron-activatable nuclides different from the first type of neutron-activatable nuclides.

14. The system of claim 13, wherein the neutron-activatable nuclides of the first type comprise ⁹⁸Mo, from which ⁹⁹Mo is produced as a first type of radionuclides through the reaction ⁹⁸Mo(n,γ)⁹⁹Mo, and wherein the neutron-activatable nuclides of the second type comprise ¹⁰⁰Mo, from which ⁹⁹Mo is produced as a second type of radionuclides through the reaction ¹⁰⁰Mo(n,2n)⁹⁹Mo.

15. The system of any one of claims 1 to 14, wherein the compact plasma-based fusion neutron source is configured to generate the neutron flux with an average neutron energy ranging from about 2 MeV to about 15 MeV.

16. The system of any one of claims 1 to 15, further comprising a neutron moderator arranged in a path of the neutron flux and configured to reduce an average neutron energy of the neutron flux prior to the neutron flux reaching the target.

17. The system of claim 16, wherein the neutron moderator is configured to reduce the average neutron energy of the neutron flux to within a range of about 0.025 eV to about 300 eV.

18. The system of any one of claims 1 to 17, further comprising a radionuclide extractor configured to receive the exposed target from the target holder and extract the produced radionuclides from the exposed target.

19. The system of any one of claims 1 to 18, further comprising a target recycling unit configured to receive the exposed target from the target holder and recycle non-activated neutron-activatable nuclides from the exposed target for use in further production of radionuclides.

20. The system of any one of claims 1 to 19, wherein the compact plasma-based fusion neutron source comprises a Z-pinch-based neutron source comprising a reaction chamber having a Z-pinch axis, the Z-pinch-based neutron source being configured to form a Z-pinch plasma along the Z-pinch axis inside the reaction chamber and generate the neutron flux from the Z-pinch plasma.

21. The system of claim 20, wherein the Z-pinch-based neutron source comprises:
a plasma confinement device comprising the reaction chamber, an inner electrode, and an outer electrode surrounding the inner electrode to define therebetween an acceleration region of the reaction chamber, the outer electrode extending axially beyond the inner electrode along the Z-pinch axis to define an assembly region of the reaction chamber adjacent the acceleration region;
a plasma formation and injection device configured to form a precursor plasma outside the reaction chamber and inject the precursor plasma inside the acceleration region; and
a main power supply configured to supply power to the plasma confinement device to apply a voltage between the inner electrode and the outer electrode to cause the precursor plasma to flow along the acceleration region and into the assembly region and to be compressed into the Z-pinch plasma along the Z-pinch axis in the assembly region.

22. The system of claim 21, wherein the plasma formation and injection device comprises:
a plasma generator configured to generate the precursor plasma; and
a plasma injector configured to inject the precursor plasma into the acceleration region.

23. The system of claim 22, wherein the plasma generator comprises:
an inner electrode; and
an outer electrode surrounding the inner electrode to define a plasma formation region therebetween, the outer electrode extending beyond the inner electrode along a plasma formation axis to enclose a plasma transport channel extending from the plasma formation region to the plasma injector along the plasma formation axis.

24. The system of claim 23, wherein the plasma formation and injection device comprises:
a process gas supply unit configured to supply a process gas into the plasma formation region; and
a plasma formation power supply configured to apply a voltage between the inner electrode and the outer electrode of the plasma generator to energize the process gas into the precursor plasma and cause the precursor plasma to flow along the plasma formation region and through the plasma transport channel to reach the plasma injector for injection of the precursor plasma into the acceleration region.

25. The system of claim 20, wherein the Z-pinch-based neutron source comprises:
a plasma confinement device comprising the reaction chamber, an inner electrode, and an outer electrode surrounding the inner electrode to define therebetween an acceleration region of the reaction chamber, the outer electrode extending axially beyond the inner electrode along the Z-pinch axis to define an assembly region of the reaction chamber adjacent the acceleration region;
a precursor gas supply device configured to supply a precursor gas inside the acceleration region; and
a main power supply configured to supply power to the plasma confinement device to apply a voltage between the inner electrode and the outer electrode to energize the precursor gas into a precursor plasma and cause the precursor plasma to flow along the acceleration region and into the assembly region and to be compressed into the Z-pinch plasma along the Z-pinch axis in the assembly region.

26. The system of any one of claims 20 to 25, wherein the Z-pinch-based neutron source is configured to form the Z-pinch plasma with an embedded radially sheared axial flow.

27. The system of any one of claims 20 to 26, wherein the target holder is configured to flow the target along a circulation path extending helically around the Z-pinch axis over an axial portion of the assembly region.

28. The system of claim 27, wherein the circulation path is disposed radially outwardly of the outer electrode.

29. The system of claim 27, wherein the circulation path is disposed inside the outer electrode.

30. The system of claim 20, wherein the Z-pinch-based neutron source comprises:
a plasma confinement device comprising the reaction chamber, a first compression electrode disposed at a first end of the reaction chamber, and a second compression electrode disposed at a second end of the reaction chamber spaced apart from the first end along the Z-pinch axis;
a precursor supply device coupled to the plasma confinement device and comprising:
an inner precursor supply unit comprising an inner injector, the inner precursor supply unit being configured to supply, through the inner injector, an inner precursor medium into the reaction chamber; and
an outer precursor supply unit comprising an outer injector disposed radially outwardly of the inner injector with respect to the Z-pinch axis, the outer precursor supply unit being configured to supply, through the outer injector, an outer precursor plasma into the reaction chamber at an outer velocity; and
a main power supply configured to supply power to the plasma confinement device to apply a voltage between the first compression electrode and the second compression electrode configured to energize and compress the inner precursor medium and the outer precursor plasma into the Z-pinch plasma with a radially sheared axial flow.

31. The system of claim 30, wherein the inner precursor medium is an inner precursor plasma, and wherein the inner precursor supply unit is configured to supply the inner precursor plasma into the reaction chamber at an inner velocity different from the outer velocity of the outer precursor plasma.

32. The system of claim 30, wherein the inner precursor medium is an inner precursor gas, and wherein the inner precursor supply unit comprises an inner precursor gas source configured to store the inner precursor gas, and an inner precursor gas supply line configured to transport the inner precursor gas from the inner precursor gas source to the inner injector for injection of the inner precursor gas into the reaction chamber.

33. The system of any one of claims 30 to 32, wherein the target holder is configured to flow the target along a circulation path extending helically around the Z-pinch axis over an axial portion of the reaction chamber.

34. The system of claim 33, wherein the circulation path is disposed outside the reaction chamber.

35. The system of any one of claims 1 to 19, wherein the compact plasma-based fusion neutron source comprises a field-reversed-configuration (FRC) neutron source configured to produce an FRC plasma and generate the neutron flux from the FRC plasma.

36. A method for radionuclide production, the method comprising:
generating a neutron flux using a compact plasma-based fusion neutron source; and
exposing a target comprising neutron-activatable nuclides to the neutron flux to produce radionuclides through neutron activation of the neutron-activatable nuclides.

37. The method of claim 36, wherein the produced radionuclides comprise ⁹⁹Mo.

38. The method of claim 37, wherein the neutron-activatable nuclides comprise ⁹⁸Mo, and wherein ⁹⁹Mo is produced from ⁹⁸Mo through the reaction ⁹⁸Mo(n,γ)⁹⁹Mo, where n stands for a neutron and γ stands for a gamma particle.

39. The method of claim 38, wherein the target comprises MoO₃ dissolved in a solution.

40. The method of any one of claims 37 to 39, wherein the neutron-activatable nuclides comprise ¹⁰⁰Mo, and ⁹⁹Mo is produced from ¹⁰⁰Mo through the reaction ¹⁰⁰Mo(n,2n)⁹⁹Mo, wherein n stands for a neutron.

41. The method of any one of claims 36 to 40, further comprising maintaining the target stationary with respect to the neutron flux during exposure of the target to the neutron flux.

42. The method of any one of claims 36 to 40, further comprising moving the target with respect to the neutron flux during exposure of the target to the neutron flux.

43. The method of claim 42, wherein moving the target with respect to the neutron flux comprises:
providing at least one conduit arranged for irradiation by the neutron flux, each conduit comprising a conduit inlet and a conduit outlet;
supplying, through the conduit inlet, a flow of the target into the at least one conduit prior to exposing the target to the neutron flux;
circulating the flow of the target along the at least one conduit while exposing the target to the neutron flux; and
discharging, through the conduit outlet, the flow of the target from the at least one conduit after exposing the target to the neutron flux.

44. The method of claim 43, wherein the at least one conduit comprises a helical pattern.

45. The method of claim 43 or 44, wherein the at least one conduit comprises a single conduit.

46. The method of claim 43 or 44, wherein the at least one conduit comprises a plurality of conduits.

47. The method of claim 46, wherein the plurality of conduits comprises a first conduit and a second conduit, and wherein circulating the flow of the target comprises circulating a first flow of the target along the first conduit and circulating a second flow of the target along the second conduit, the first flow of the target comprises a first type of neutron activatable nuclides and the second flow of the target comprises a second type of neutron activatable nuclides different from the first type of neutron activatable nuclides.

48. The method of claim 47, wherein the neutron-activatable nuclides of the first type comprise ⁹⁸Mo, from which ⁹⁹Mo is produced as a first type of radionuclides through the reaction ⁹⁸Mo(n,γ)⁹⁹Mo, and wherein the neutron-activatable nuclides of the second type comprise ¹⁰⁰Mo, from which ⁹⁹Mo is produced as a second type of radionuclides through the reaction ¹⁰⁰Mo(n,2n)⁹⁹Mo.

49. The method of any one of claims 36 to 48, wherein generating the neutron flux comprises generating the neutron flux with an average neutron energy ranging from about 2 MeV to about 15 MeV.

50. The method of any one of claims 36 to 49, further comprising moderating the neutron flux to reduce an average neutron energy of the neutron flux prior to the neutron flux reaching the target.

51. The method of claim 50, wherein moderating the neutron flux comprises reducing the average neutron energy of the neutron flux to within a range of about 0.025 eV to about 300 eVI.

52. The method of any one of claims 36 to 51, further comprising extracting the produced radionuclides from the exposed target.

53. The method of any one of claims 36 to 52, further comprising recycling non-activated neutron-activatable nuclides from the exposed target for use in further production of radionuclides.

54. The method of any one of claims 36 to 53, further comprising providing the compact plasma-based fusion neutron source as a Z-pinch-based neutron source comprising a reaction chamber having a Z-pinch axis, the Z-pinch-based neutron source being configured to form a Z-pinch plasma along the Z-pinch axis inside the reaction chamber and generate the neutron flux from the Z-pinch plasma.

55. The method of claim 54, further comprising providing the Z-pinch-based neutron source with a plasma confinement device comprising the reaction chamber, an inner electrode, and an outer electrode surrounding the inner electrode to define therebetween an acceleration region of the reaction chamber, the outer electrode extending axially beyond the inner electrode along the Z-pinch axis to define an assembly region of the reaction chamber adjacent the acceleration region, and wherein generating the neutron flux comprises:
forming a precursor plasma outside the reaction chamber;
introducing the precursor plasma into an acceleration region; and
supplying power to the plasma confinement device to apply a voltage between the inner electrode and the outer electrode configured to cause the precursor plasma to flow along the acceleration region and into the assembly region and to be compressed into the Z-pinch plasma along the Z-pinch axis in the assembly region.

56. The method of claim 55, wherein:
forming the precursor plasma comprises:
supplying a process gas into a plasma formation region of a plasma generator; and
supplying power to the plasma generator to apply a voltage across the plasma formation region configured to energize the process gas into the precursor plasma; and
introducing the precursor plasma into the acceleration region comprises flowing the precursor plasma from the plasma formation region to the acceleration region.

57. The method of claim 54, further comprising providing the Z-pinch-based neutron source with a plasma confinement device comprising the reaction chamber, an inner electrode, and an outer electrode surrounding the inner electrode to define therebetween an acceleration region of the reaction chamber, the outer electrode extending axially beyond the inner electrode along the Z-pinch axis to define an assembly region of the reaction chamber adjacent the acceleration region, and wherein generating the neutron flux comprises:
supplying a precursor gas inside acceleration region; and
supplying power to the plasma confinement device to apply a voltage between the inner electrode and the outer electrode configured to energize the precursor gas into a precursor plasma and cause the precursor plasma to flow along the acceleration region and into the assembly region and to be compressed into the Z-pinch plasma along the Z-pinch axis in the assembly region.

58. The method of any one of claims 55 to 57, wherein the Z-pinch-based neutron source is configured to form the Z-pinch plasma with an embedded radially sheared axial flow.

59. The method of any one of claims 55 to 58, further comprising flowing the target along a circulation path extending helically around the Z-pinch axis over an axial portion of the assembly region.

60. The method of claim 59, further comprising disposing the circulation path radially outwardly of the outer electrode.

61. The method of claim 59, further comprising disposing the circulation path radially inside the outer electrode.

62. The method of claim 54, further comprising providing the Z-pinch-based neutron source with a plasma confinement device comprising the reaction chamber, a first compression electrode disposed at a first end of the reaction chamber, and a second compression electrode disposed at a second end of the reaction chamber spaced apart from the first end along the Z-pinch axis, and wherein generating the neutron flux comprises:
supplying, through an inner injector, an inner precursor medium into the reaction chamber;
supplying, through an outer injector disposed radially outwardly of the inner injector with respect to the Z-pinch axis, an outer precursor plasma into the reaction chamber at an outer velocity; and
supplying power to the plasma confinement device to apply a voltage between the first compression electrode and the second compression electrode configured to energize and compress the inner precursor medium and the outer precursor plasma into the Z-pinch plasma with a radially sheared axial flow.

63. The method of claim 62, wherein supplying the inner precursor medium into the reaction chamber comprises supplying, as the inner precursor medium, an inner precursor plasma into the reaction chamber at an inner velocity different from the outer velocity of the outer precursor plasma.

64. The method of claim 62, wherein supplying the inner precursor medium into the reaction chamber comprises supplying, as the inner precursor medium, an inner precursor gas into the reaction chamber.

65. The method of any one of claims 62 to 64, further comprising flowing the target along a circulation path extending helically around the Z-pinch axis over an axial portion of the reaction chamber.

66. The method of claim 65, further comprising disposing the circulation path outside the reaction chamber.

67. The method of any one of claims 36 to 53, further comprising providing the compact plasma-based fusion neutron source as a field-reversed-configuration (FRC) neutron source configured to produce an FRC plasma and generate the neutron flux from the FRC plasma.
